(19) United States
(12) Patent Application Publication
(10) Pub. No.: US 2026/0304035 A1
(43) Pub. Date: Oct. 1, 2026

(54) MICROPHONE ASSEMBLY WITH MULTIMODAL INTERFACES AND SENSORS

(71) Applicant: Logitech Europe S.A., Lausanne (CH)

(72) Inventors: Clayton Christopher WILLIAMSON, Moorpark, CA (US); Richard Richard SUNG, Los Angeles, CA (US); Darrell Robert HAYES, Westlake Village, CA (US); Sal Gregory GARCIA, Moorpark, CA (US); Aron Michael ROSENBERG, Lafayette, CA (US)

(21) Appl. No.: 19/096,678

(22) Filed: Mar. 31, 2025

(51) Int. Cl. H04R 3/00; H04R 1/40; H04R 29/00

(52) U.S. Cl. CPC H04R 3/005; H04R 1/406; H04R 29/008; H04R 2410/01

(57) ABSTRACT

A microphone assembly includes a microphone, a microphone control system, and a visual display system. The microphone includes a first microphone capsule having a first polar pattern and a second microphone capsule having a second polar pattern. The microphone control system is configured to receive a first audible signal from the first microphone capsule, receive a second audible signal from the second microphone capsule, and generate a third polar pattern for the microphone based on the first audible signal and the second audible signal. The visual display system is configured to display a representation of the third polar pattern relative to the microphone.

### BACKGROUND

### Field

Embodiments of the present disclosure generally relate to a microphone assembly and a microphone system.

### Description of the Related Art

A microphone is a transducer for converting acoustic waves to electrical signals. One type of microphones include a diaphragm or other flexible element that moves in response to incident acoustic waves. The motion of the diaphragm is then sensed by an electrical circuit to create an electrical signal. A second type of microphone will include a condenser microphone which also converts acoustic signals into electrical signals. Condenser microphones are generally more sensitive to and can detect more nuances in a received acoustic signal. This sensitivity makes them well-suited for recording vocals and acoustic instruments.

A polar pattern of a microphone defines the microphone's sensitivity to sounds arriving from different directions around the microphone. In many sound capture scenarios, the sounds include both desirable sounds to capture such as the voice of a person speaking into the microphone and also undesirable sounds to capture (i.e., noise) such as clicks from the person's keyboard, air conditioning vent provided noise, or voices of other people that are not speaking into the microphone. Accordingly, the polar pattern of the microphone should be sensitive in arrival directions of the desirable sounds and insensitive in arrival directions of the undesirable noise generated from an audible source.

Microphones are available that have multiple polar patterns for capturing sounds such as patterns that are equally sensitive in all directions, patterns that are sensitive in the front and the back and insensitive from the sides, patterns that are only sensitive in the front, and other patterns. When changing a polar pattern for a microphone, it may be difficult to anticipate actual locations of nodes (where sounds are captured) and nulls (where sounds are rejected) in the new polar pattern for the microphone.

Therefore, there is a need for an improved microphone system that overcomes the deficiencies described above.

### SUMMARY

Embodiments of the disclosure provide a microphone assembly that includes a microphone, a microphone control system, and a visual display system. The microphone includes a first microphone capsule having a first polar pattern and a second microphone capsule having a second polar pattern. The microphone control system is configured to receive a first audible signal from the first microphone capsule, receive a second audible signal from the second microphone capsule, and generate a third polar pattern for the microphone based on the first audible signal and the second audible signal. The visual display system is configured to display a representation of the third polar pattern relative to the microphone.

Embodiments of the disclosure provide a method that includes receiving a first audible signal from a first microphone capsule having a first polar pattern. The method further includes receiving a second audible signal from a second microphone capsule having a second polar pattern. A third polar pattern for the microphone is generated based on the first audible signal and the second audible signal. The method further includes displaying a visual representation of the third polar pattern relative to a microphone.

Embodiments of the disclosure include a microphone assembly, comprising: a first microphone capsule configured to generate a first capsule polar pattern; a second microphone capsule configured to generate a second capsule polar pattern, wherein the first microphone capsule and the second microphone capsule are each aligned relative to a first direction; a microphone control system configured to: receive a first audible signal from the first microphone capsule; receive a second audible signal from the second microphone capsule; and generate a microphone polar pattern based on a combination of the first capsule polar pattern and the second capsule polar pattern; and a visual display system comprising a display that is configured to display a characteristic of the generated microphone polar pattern based on information received from the microphone control system.

Embodiments of the disclosure may further include a microphone assembly, comprising: a first microphone capsule configured to generate a first capsule polar pattern; a second microphone capsule configured to generate a second capsule polar pattern, wherein the first microphone capsule and the second microphone capsule are each aligned relative to a first direction; a microphone control system configured to: receive a first audible signal from the first microphone capsule; receive a second audible signal from the second microphone capsule; and generate a microphone polar pattern based on a combination of the first capsule polar pattern and the second capsule polar pattern; one or more proximity sensors having a field-of-view that is aligned relative to the first direction, and the one or more proximity sensors are configured to detect an angular position relative to the first direction and distance of an object positioned within the field-of-view from the one or more proximity sensors; and a visual display system comprising a display that is configured to display a representation of the object.

Embodiments of the disclosure may further include a microphone assembly, comprising: a first microphone capsule configured to generate a first capsule polar pattern; a second microphone capsule configured to generate a second capsule polar pattern, wherein the first microphone capsule and the second microphone capsule are each aligned relative to a first direction; a microphone control system configured to: receive a first audible signal from the first microphone capsule; receive a second audible signal from the second microphone capsule; and generate a microphone polar pattern based on a combination of the first capsule polar pattern and the second capsule polar pattern; and one or more proximity sensors having a field-of-view that is aligned relative to the first direction, and the one or more proximity sensors are configured to detect an angular position relative to the first direction or a distance of an object positioned within the field-of-view from the one or more proximity sensors.

Embodiments of the disclosure may further include an audio collection method, comprising: receiving a first audible signal from a first microphone capsule of a microphone assembly having a first capsule polar pattern, wherein the first microphone capsule is aligned relative to a first direction; receiving a second audible signal from a second microphone capsule of the microphone assembly having a second capsule polar pattern, wherein the second microphone capsule is aligned relative to the first direction; generate a microphone polar pattern based on a combination of the first capsule polar pattern and the second capsule polar pattern; detecting, by use of one or more proximity sensors, a position an object relative to the one or more proximity sensors; and altering a characteristic of the generated microphone polar pattern based on the detected relative position of the object to the one or more proximity sensors.

Embodiments of the disclosure may further include a microphone assembly, comprising: a first microphone capsule configured to generate a first capsule polar pattern; a second microphone capsule configured to generate a second capsule polar pattern; a microphone control system configured to: receive a first audible signal from the first microphone capsule; receive a second audible signal from the second microphone capsule; and generate a microphone polar pattern based on a combination of the first capsule polar pattern and the second capsule polar pattern; and a visual display system comprising an array of display elements configured to display a representation of the microphone polar pattern that is aligned relative to the microphone assembly.

Embodiments of the disclosure may further include an audio collection method, comprising: receiving a first audible signal from a first microphone capsule of a microphone assembly having a first capsule polar pattern; receiving a second audible signal from a second microphone capsule of the microphone assembly having a second capsule polar pattern; generate a microphone polar pattern based on a combination of the first capsule polar pattern and the second capsule polar pattern; and displaying a visual representation of the microphone polar pattern relative to the of a microphone assembly.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1A is a perspective view of a microphone system according to one or more embodiments.

FIG. 1B is a perspective view of a microphone system that includes a visual display system and a display device according to one or more embodiments.

FIG. 2A is a schematic perspective view of a microphone assembly with two opposite facing microphone capsules according to one or more embodiments.

FIG. 2B is a schematic perspective view of a microphone assembly with two microphone capsules facing in one direction according to one or more embodiments.

FIG. 2C is a schematic perspective view of a microphone assembly with three microphone capsules each facing in one of two perpendicular directions according to one or more embodiments.

FIG. 2D is a schematic perspective view of a microphone assembly with four microphone capsules each facing in one of two perpendicular directions according to one or more embodiments.

FIG. 2E is a schematic perspective view of a microphone assembly with four microphone capsules each facing in one of two opposite directions according to one or more embodiments.

FIG. 2F is a schematic perspective view of a microphone assembly with four microphone capsules each facing in a different direction according to one or more embodiments.

FIG. 3 is a schematic diagram illustrating a microphone control system according to one or more embodiments.

FIG. 4 is a schematic representation of displaying a figure eight polar pattern formed for a microphone system according to one or more embodiments.

FIG. 5 is a schematic representation of displaying an omnidirectional polar pattern formed for a microphone system according to one or more embodiments.

FIG. 6 is a schematic representation of displaying a cardioid polar pattern formed for a microphone system according to one or more embodiments.

FIG. 7 is a schematic representation of displaying a hypercardioid polar pattern formed for a microphone system according to one or more embodiments.

FIG. 8 is a schematic representation of displaying a supercardioid polar pattern formed for a microphone system according to one or more embodiments.

FIG. 9 is a schematic representation of displaying a subcardioid polar pattern formed for a microphone system according to one or more embodiments.

FIG. 10 is a schematic representation of displaying a second order cardioid polar pattern formed for a microphone system according to one or more embodiments.

FIG. 11 is a schematic representation of displaying a second order hypercardioid polar pattern formed for a microphone system according to one or more embodiments.

FIG. 12 is a schematic representation of displaying a second order supercardioid polar pattern formed for a microphone system according to one or more embodiments.

FIG. 13 is a schematic representation of a visual indication of a first location of a user relative to an orientation of a microphone system according to one or more embodiments.

FIG. 14 is a schematic representation of a visual indication of a second location of a user relative to a microphone system according to one or more embodiments.

FIG. 15 is a schematic representation of a visual indication of a third location of a user relative to a microphone system according to one or more embodiments.

FIGS. 16-17 are schematic representations of varying visual indications created by a differing detected distance between a user and a microphone assembly according to one or more embodiments.

FIG. 18 is a schematic representation of displaying a visual indication of detecting no users relative to a microphone assembly according to one or more embodiments.

FIG. 19 is a schematic representation of an example of a user interaction relative to a microphone system according to one or more embodiments.

FIG. 20 illustrates an example of various attributes that can be detected by a sensor assembly of a microphone assembly, according to one or more embodiments.

FIG. 21 is a front view of a microphone system that includes a display device, according to one or more embodiments.

FIG. 22 is a schematic representation of alternate visual displays that can be generated on a display device within a microphone system, according to one or more embodiments.

FIG. 23 illustrates a plurality of screenshots that can be separately generated on a display device within a microphone system, according to one or more embodiments.

FIG. 24A-24C illustrate detailed examples of screenshots that can be separately generated on a display device within a microphone system, according to one or more embodiments.

FIG. 25A illustrates a cardioid polar pattern oriented in a first orientation relative to a front region of a microphone system, according to one or more embodiments.

FIG. 25B illustrates a screenshot of a simplified graphical display of the cardioid polar pattern illustrated in FIG. 25A generated on a display device within a microphone system, according to one or more embodiments.

FIG. 26A illustrates a cardioid polar pattern oriented in a second orientation relative to a front region of a microphone system, according to one or more embodiments.

FIG. 26B illustrates a screenshot of a simplified graphical display of the cardioid polar pattern illustrated in FIG. 26A generated on a display device within a microphone system, according to one or more embodiments.

FIG. 27A illustrates a frequency spectrum plot of an audible signal received by an electronic device or an audio device, according to one or more embodiments.

FIG. 27B illustrates frequency spectrums for sound generated by different types of peripheral devices that can be used within one or more models, according to one or more embodiments.

FIG. 27C illustrates a denoised frequency spectrum plot of denoised audio data that is generated based on the noise suppression activities performed on the audible signal shown in FIG. 27A, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to a microphone system that includes one or more transducers capable of detecting audible signals received from various sources disposed within an environment that surrounds the microphone system. In some embodiments, the one or more transducers include one or more microphone capsules that are each configured to generate or form a capsule polar pattern that affects the sensitivity of the microphone capsule to audible signals (i.e., sound) arriving from different directions. During operation, the microphone system is configured to form a microphone polar pattern, or for ease of discussion purposes, simply a polar pattern, that is generated by the combination of the capsule polar patterns of each of the microphone capsules. By adjusting the combination of the capsule polar patterns, the sensitivity of the microphone system to sounds arriving from different directions in the environment surrounding the microphone system can be adjusted and tailored to improve the quality audible signal received and then transferred to one or more electronic devices. Combining and adjusting aspects of the formed capsule polar patterns can be used to form configurable microphone polar patterns to meet a user's need versus fixed polar patterns commonly found in conventional microphone designs. An advantage of the microphone system(s) disclosed herein includes the reduction in noise collected by a microphone due to the ability to generate, visualize, orient, and adjust the formed polar patterns that are not sensitive to sounds received in arrival directions that are not in the desired primary sound collection direction. A further advantage of the microphone system(s) disclosed herein includes the ability to generate continuously adjustable polar patterns using minimal processing and computational resources.

One or more of the embodiments disclosed herein include a microphone system that is adapted to provide a user and/or a control system information relating to sources of audible signals and the generated polar pattern to allow the user to manually adjust, or the control system to automatically adjust, one or more characteristics of the microphone system to improve the quality of a received desired audible signal and reject unwanted audible signals received from different sources (e.g., noise sources). The apparatus and methods described herein will also allow a user to visualize and adjust its position and/or proximity to the microphone system so that the desired audible signal source is in a preferred position relative to the microphone system. The one or more characteristics of the microphone system that can be adjusted can include but are not limited to, the adjustment of a polar pattern created by one or more of the transducers (e.g., capsules) within the microphone system and the orientation of the polar pattern relative to the source of the audible signal.

### Microphone System Example

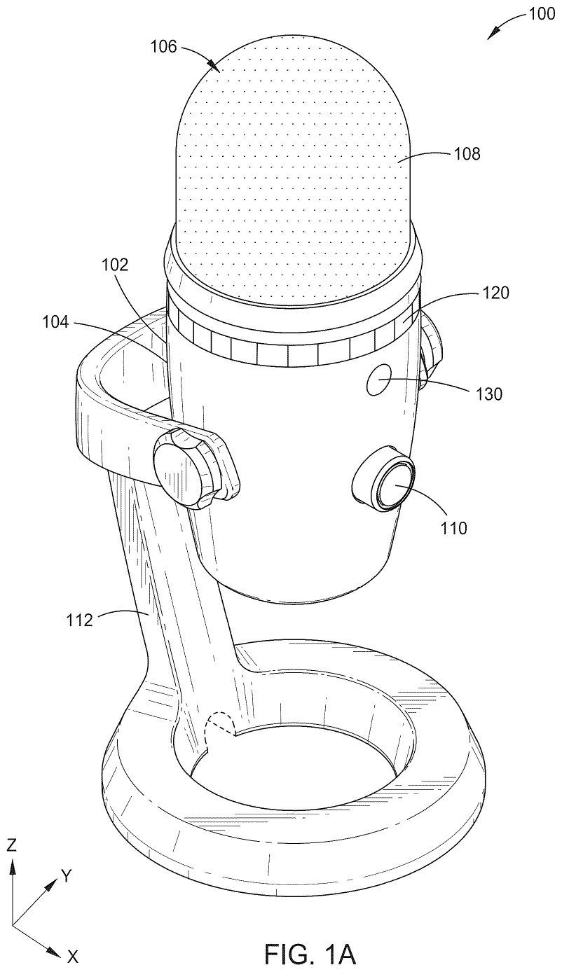

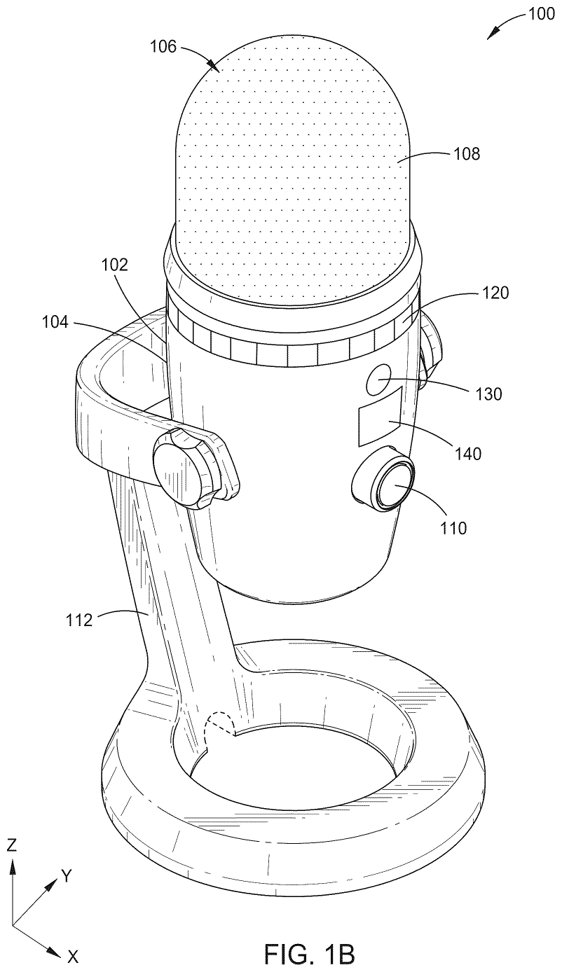

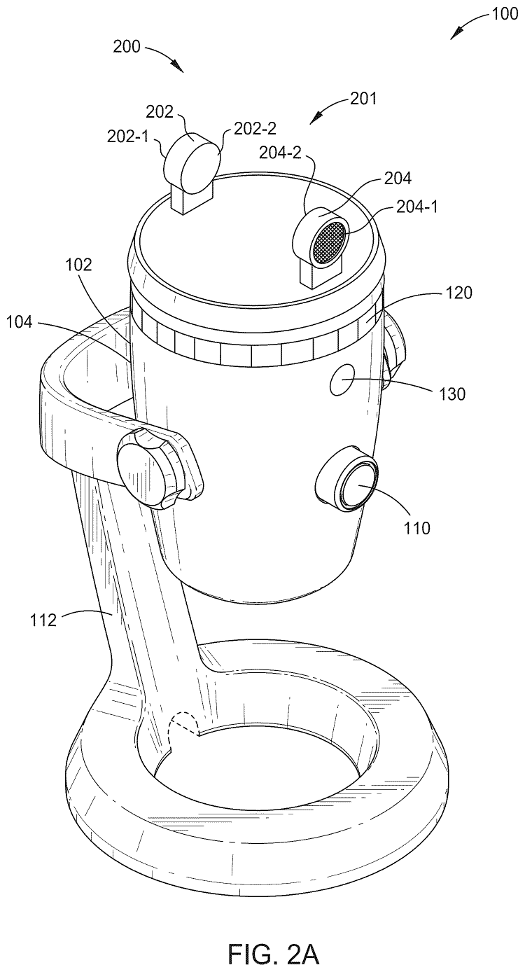

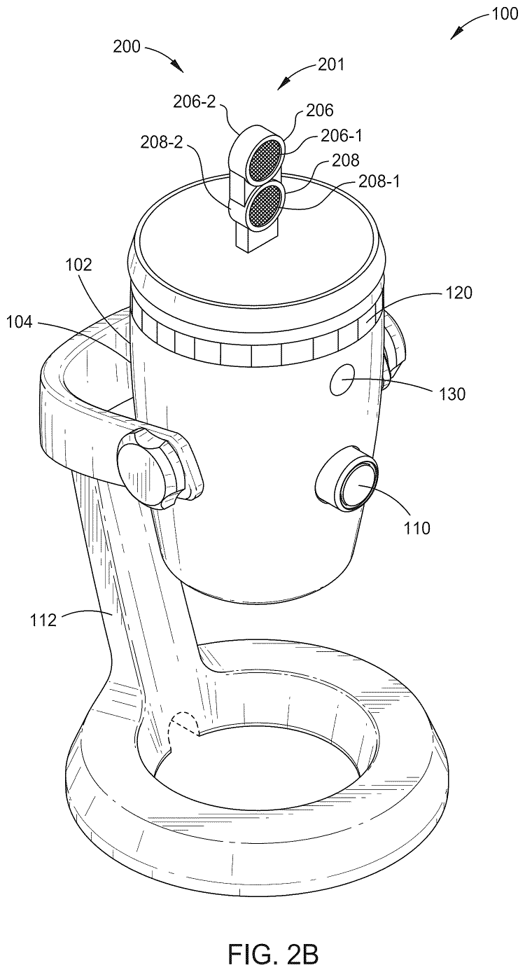

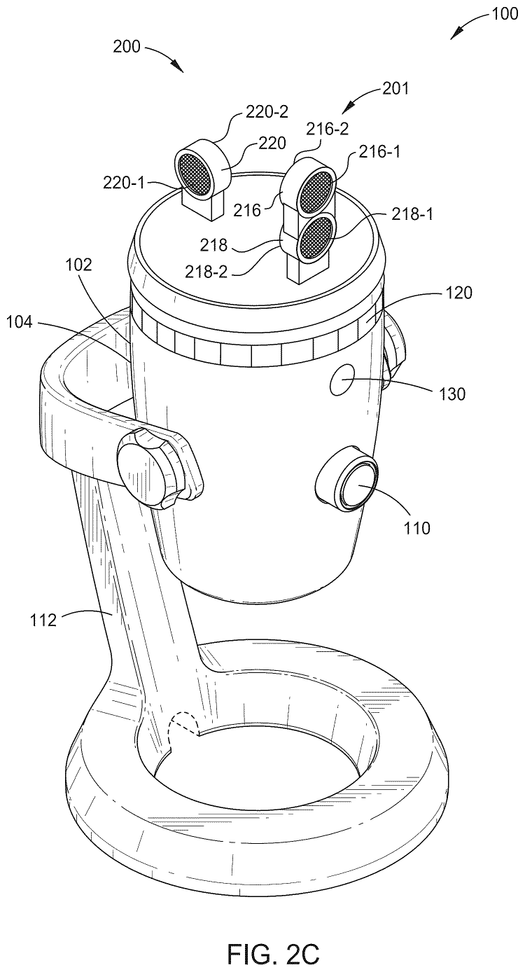

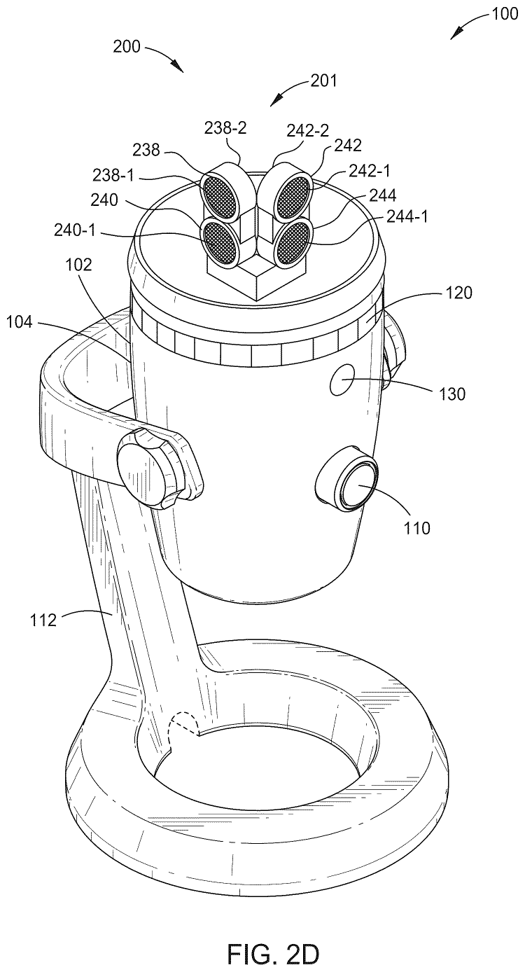

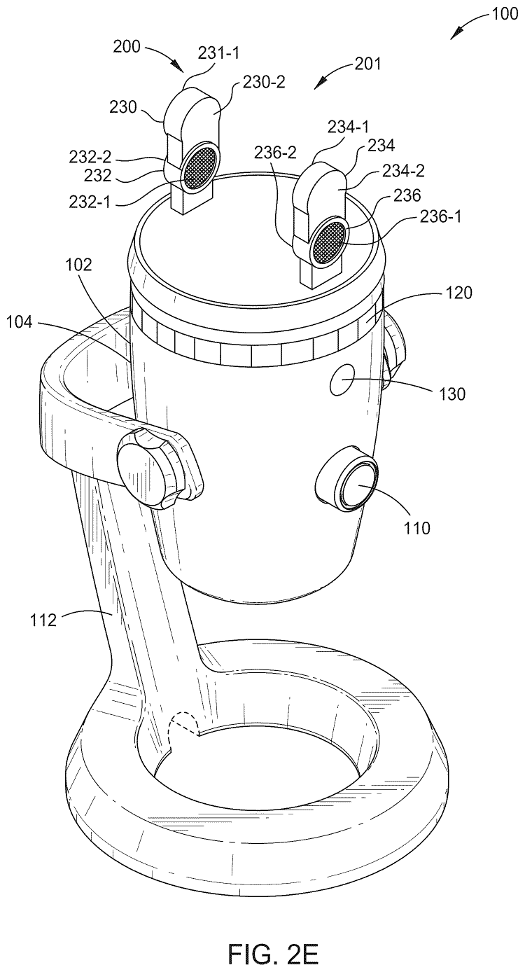

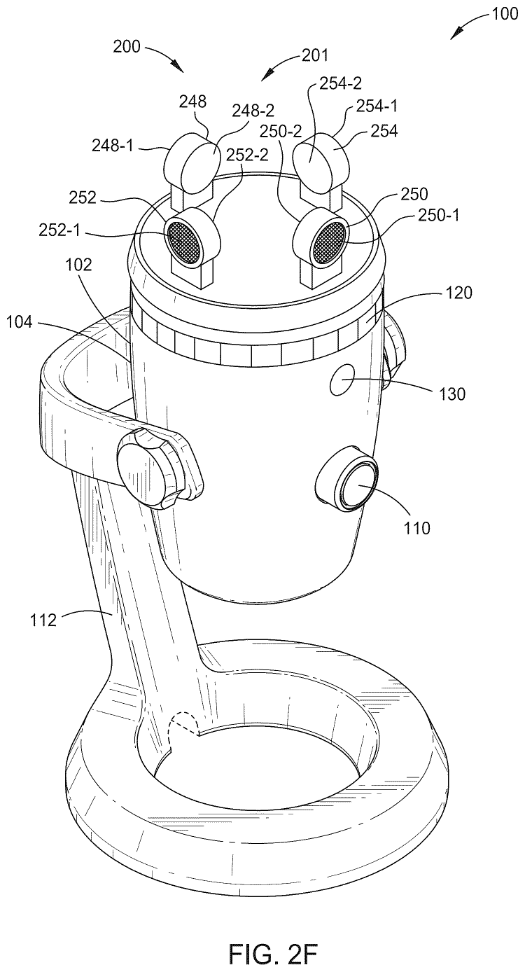

FIG. 1A is a perspective view of a microphone system 100. The microphone system 100 includes a housing 102 and a microphone assembly 200 (illustrated in FIGS. 2A-2F) that is encased within the housing 102. The housing 102 includes a body 104 and a cover 106. The microphone assembly 200 is disposed on the body 104 and under the cover 106. The microphone system 100 can include a front face 108 that is designed to face a direction in which an audible signal generated from a desired audible source is likely to be received, such as a user that is directly speaking into the microphone system 100.

The cover 106 is acoustically transparent and audible signals (e.g., sound that includes acoustic waves) that pass through the cover 106 maintain acoustic fidelity to the microphone assembly 200 inside the cover 106. The microphone system 100 further includes a switch 110 that allows a user (not shown) to configure various features of the microphone system 100. In some embodiments, the microphone system 100 is supported by a stand 112.

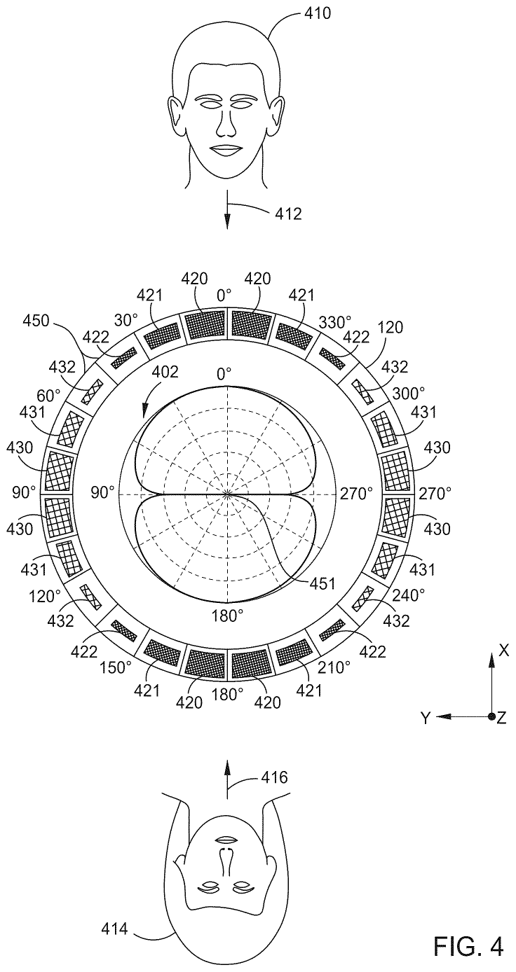

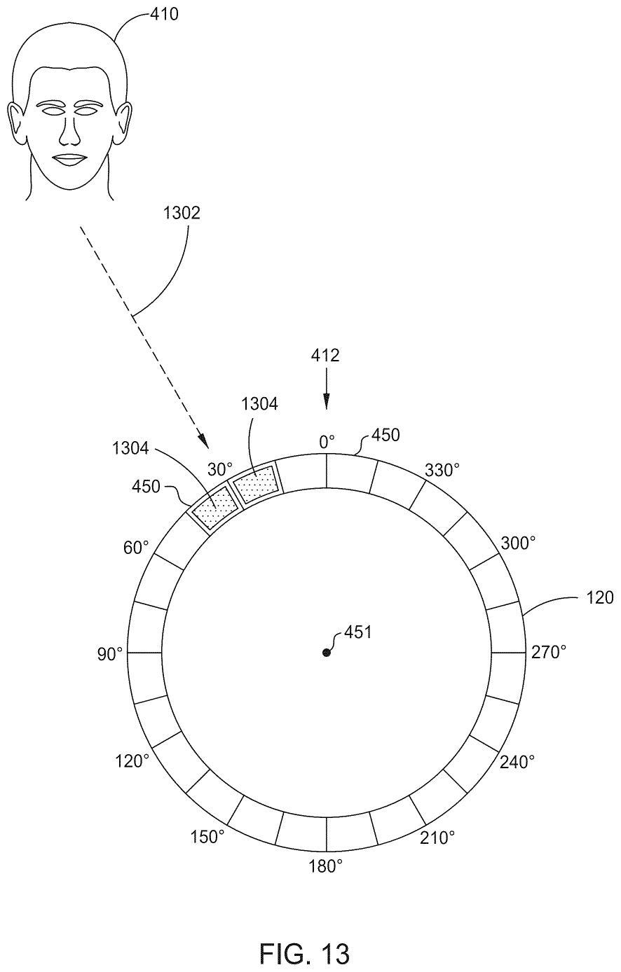

As shown in FIG. 1A, the microphone system 100 includes a visual display system 120. In some embodiments, the microphone system 100 includes a visual display system 120 and a sensor system 130. The sensor system 130 will include one or more sensors (e.g., proximity sensors) that are configured to detect one or more properties of the environment within the sensor's detection range. In some embodiments, one or more sensors of the sensor system 130 detect the presence of a user (e.g., user 410 in FIG. 13) in a first location relative to the microphone system 100. In various embodiments, the sensor system 130 includes a proximity sensor such as, for example, a single-zone proximity sensor having a field of view (FOV) that is defined by an angle, such as a viewing angle measured in the horizontal plane of about 10° to about 180°, such as an angle of about 15° to about 90°. In some embodiments, the field of view (FOV) has an acute angle of between about 10° and about 90°, such as between about 18° and about 90°. In some embodiments, the FOV is oriented so that an angle bisector of the FOV angle is aligned in a desired direction, such as a direction 412 (FIGS. 4-12) that can be associated with an optimal position of a user. In one or more embodiments, the sensor system 130 includes a multi-zone proximity sensor having a FOV of about 90°. The multi-zone proximity sensor can be adapted to detect the orientation and relative position of a user or audible source in relation to the position of the multi-zone proximity sensor and microphone system 100. In some embodiments, the sensor system 130 is specifically configured not to include an image capture device (e.g., a camera). In these embodiments, by not including the image capture device, the sensor system 130 and microphone system 100 are configured to address any privacy concerns associated with image captures and facial recognition. In some embodiments, the sensor system 130 includes multiple proximity sensors of different types and/or configurations. In some embodiments, multiple proximity sensors are positioned around an external surface of the body 104 so as to provide a FOV of greater than about 60°, or greater about 90°, or greater than 180°, such as up to 360° around the microphone system 100.

The sensor system 130 may also include one or more functional subsystems such as a subsystem for voice activity detection (VAD). In some examples, the subsystem for VAD is capable of determining whether or not human speech is present in an audible signal. In one or more embodiments, the subsystem for VAD can classify sources of sounds such as a barking dog, a car engine, HVAC-generated noise, or a human voice using one or more machine learning models as described below. In some embodiments, the sensor system 130 includes one or more optical sensors that are configured to detect the temperature of objects within its field-of-view (FOV), such as an IR sensor. In some embodiments, the sensor system 130 includes a camera that is configured to generate a digital image of objects within its FOV so that a control system can detect features, such as the position of and number of people, within the environment in which the microphone system 100 is positioned.

In some embodiments, the visual display system 120 is configured to display a variety of information related to the audible signal information that the microphone system 100 is receiving from various audible sources and/or the operational status of the microphone system 100 and the microphone assembly 200. In certain embodiments, the visual display system 120 and a control system, which is described further below, are configured to provide an indication of characteristics of audible signals received from one or more audible sources positioned at different locations relative to the microphone system 100. In one example, the visual display system 120 and control system, can be used to provide information relating to the position of an audible source relative to the microphone assembly 200 and/or the intensity of the sound (SPL) received from various audible sources positioned at different locations relative to the microphone system 100.

In one or more embodiments, the visual display system 120 is configured to graphically display information relating to an orientation and characteristics of a polar pattern generated by use of a microphone assembly 200 disposed within the microphone system 100. In various embodiments, the visual display system 120 includes light emitting elements, such as light emitting diodes (LEDs), positioned around the housing 102 such that the visual display system 120 can indicate features of a generated polar pattern by illuminating one or more of the light emitting elements. In certain embodiments, the LEDs are capable of generating light of multiple different colors (e.g., different wavelengths) at different intensity levels. For example, as will be discussed further below, the visual display system 120 can indicate the features of the polar pattern via the LEDs using light of different colors and intensities.

As described below, the visual display system 120 displays the graphical representation of a polar pattern with indications of nodes where the microphone assembly 200 is relatively sensitive to received audible signals (i.e., sound) and indications of nulls where the microphone assembly 200 is relatively insensitive to received audible signals (i.e., sound). In one or more embodiments, displaying the representation of the polar pattern allows the user to visualize and adjust the orientation of the generated polar pattern relative to the microphone assembly, and/or adjust the position of the microphone system 100 or themselves such that desirable sounds are directed towards the indications of the nodes and that undesirable sounds are directed towards the indications of the nulls. Since the microphone assembly 200 is capable of forming many different types of polar patterns, displaying the representation of the polar pattern visually by use of the visual display system 120 indicates to the user the polar pattern that is currently being used by the microphone assembly 200, and thus allows the user to select or adjust the generated polar pattern to improve the quality of the audible signal captured and transmitted to an external electronic device. The captured audible signal(s) received by the components within the microphone assembly 200 are configured to process and transmit the captured audible signal(s) to an external electronic device by use of one or more communication paths, such as a digital audio communication link (e.g., USB link) and/or an XLR communication link. External electronic devices can include a laptop, video conferencing equipment, audio system components (e.g. speaker, mixer, etc.), smart phone, or other useful electronic device.

In some embodiments, the polar pattern that is currently formed for the microphone assembly 200 is one of a number of predefined polar patterns that are formed by use of the control system, such as the polar patterns illustrated in FIGS. 4-12. In other embodiments, as described below, the polar pattern can be continuously adjustable by use of the control system and input from a user of the microphone assembly 200. In an example in which the polar pattern that is currently formed for the microphone assembly 200 is adjusted by the user (e.g., via interaction with the switch 110 or another interface device), displaying the representation of the polar pattern allows the user to visualize how the polar pattern is changing based on user inputs in substantially real-time. For example, the user can change locations of nodes of the polar pattern to align the nodes with arrival directions of sounds that are desirable to capture. Similarly, the user can also change locations of nulls of the polar pattern to align the nulls with arrival directions of sounds that are not desirable to capture (e.g., noise).

FIG. 1B is a perspective view of a microphone system 100 that includes a display device 140. In various embodiments, the display device 140 is configured to visually display information in addition to or alternative to information displayed the visual display system 120. In certain embodiments, the display device 140 includes a digital display device configured to display glyphs, numerical values, or other information related to the shape of the polar pattern (e.g., graphical representation of the currently generated polar pattern), the polar pattern beam widths value, detection angles, non-zero gains, or other metrics. In one example, the display device is configured to display a representation of the figure eight polar pattern 402 illustrated in FIG. 4. The display device 140 can include an array of LEDs, a liquid crystal display (LCD), an in-plane switching liquid crystal display (IPS-LCD), an organic light-emitting diode (OLED), or an active-matrix organic light-emitting diode (AMOLED) type of display device, for example.

In one or more examples, the display device 140 is configured to display a representation of the polar pattern that is currently formed for the microphone assembly 200. For example, the display device 140 may display a three-dimensional representation of the polar pattern that is currently being formed by the microphone assembly 200. In some embodiments, the display device 140 can be used to represent the varying shape of the generated polar pattern as it is being adjusted by the user or the control system. In some embodiments, the display device 140 is configured to receive user inputs such as interactions by the user relative to the display device 140 (e.g., the display device 140 may include a touchscreen). In one or more embodiments, the display device 140 may display information that is related to information displayed by the visual display system 120 which can be augmented by use of the sensor system 130.

Consider an example in which the user interacts with the switch 110, the display device 140, and/or the sensor system 130 to specify a polar pattern to be formed for the microphone assembly 200. In this example, the visual display system 120 displays a representation of the polar pattern relative to the body 104 and the cover 106 including indications of nodes and nulls. The sensor system 130 may detect a location of the user using one or more proximity sensors, and the display device 140 can display angles between the location of the user and the nodes and the nulls of the polar pattern currently formed for the microphone assembly 200. For example, the user may further interact relative to input devices of the microphone system 100 to adjust locations of the nodes and the nulls based on the angles displayed by the display device 140. In some cases, the display device 140 can display a representation of a polar pattern (e.g., figure eight polar pattern 402) while the visual display system 120 simultaneously displays an azimuthal representation of the polar pattern relative to the body 104.

### Microphone Assembly Examples

FIGS. 2A-2F each illustrate an example of microphone assembly 200 configurations that can be used to perform one of more of the methods and/or aspects of the disclosure provided herein. As shown in FIGS. 2A-2F each microphone assembly 200 will include one or more capsules within a capsule assembly 201 that are each positioned and oriented in desired directions. While the discussion surrounding FIGS. 2A-2F primarily discloses the use of one or more microphone capsules this configuration of the microphone assembly 200 is not intended to be limiting to the scope of the disclosure provided herein, since other types and configurations of audible signal detecting transducers can be used.

FIG. 2A is a schematic perspective view of a microphone assembly 200 with two opposite facing microphone capsules. As shown, the microphone system 100 is illustrated with the cover 106 removed in order to view the audible signal detecting portion of the microphone assembly 200. The microphone assembly 200 illustrated in FIG. 2A includes a first microphone capsule 202 facing in a first direction and a second microphone capsule 204 facing in a second direction that is opposite of the first direction. The first microphone capsule 202 includes a front face 202-1 and a backside 202-2 and the second microphone capsule 204 also includes a front face 204-1 and a backside 204-2.

In various embodiments, the first microphone capsule 202 is configured to generate a first audible signal based on a first capsule polar pattern and the second microphone capsule 204 that is configured to generate a second audible signal based on a second capsule polar pattern. In some embodiments, it may be undesirable for the microphone assembly 200 to record audible signals (e.g., acoustic waves) using the first capsule polar pattern or the second capsule polar pattern. In one or more examples, it has been found that by weighting and summing the generated first and second capsule polar patterns, many different polar patterns can be formed for the microphone assembly 200. By way of example, if the first and second microphone capsules 202, 204 are both cardioid microphone capsules with first and second cardioid capsule polar patterns, respectively, then an omnidirectional polar pattern can be formed for the microphone assembly 200 by summing the first capsule polar pattern and the second capsule polar pattern. Similarly, a figure eight polar pattern may be formed for the microphone assembly 200 by subtracting the second capsule polar pattern from the first capsule polar pattern if the first and second microphone capsules 202, 204 are both cardioid microphone capsules.

The weighting factors (WF) used to combine the capsule polar patterns by summing their weighted capsule polar patterns can be greater than or equal to zero or less than or equal to zero, such as in a range between −1≤WF≤1. During operation, a polar pattern can be formed, altered, or adjusted based on a user's input provided to the control system and applied to microphone assembly 200, wherein, for example, adjustment of the switch 110 can be used to adjust one or more of the weighting factors applied to one or more of the summed capsule polar patterns to alter the type polar pattern that is generated by the microphone assembly 200.

FIG. 2B is a schematic perspective view of a microphone assembly 200 with two microphone capsules facing in one direction. The microphone assembly 200 of FIG. 2B includes a first microphone capsule 206 facing in a first direction and a second microphone capsule 208 that is also facing in the first direction. As shown, the first microphone capsule 206 is disposed on the second microphone capsule 208. The first microphone capsule 206 includes a front face 206-1 and a backside 206-2. The second microphone capsule 208 also includes a front face 208-1 and a backside 208-2. As shown, the front faces 206-1, 208-1 each face in the first direction, which can be in a direction that the front face 108 is facing, or a direction in which an audible signal generated from a desired audible source is likely to be received from.

In some embodiments, the first and second microphone capsules 206, 208 are different types of microphone capsules. In one example, one of the first and second microphone capsules 206, 208 is a figure eight microphone capsule and the other one of the first and second microphone capsules 206, 208 is an omnidirectional microphone capsule. In various examples, the first microphone capsule 206 is configured to generate a first capsule polar pattern based on the figure eight polar pattern and the second microphone capsule 208 is configured to generate a second capsule polar pattern based on the omnidirectional polar pattern. As described above and below, it has been found that by weighting and summing the first and second capsule polar patterns, many different polar patterns can be formed for the microphone assembly 200. For example, a figure eight polar pattern may be formed for the microphone assembly 200 by applying a weight of 1.0 to the first capsule polar pattern generated by the first microphone capsule 206 and a weight of zero to the second capsule polar pattern generated by the second microphone capsule 208. An omnidirectional polar pattern can be formed for the microphone assembly 200 by applying a weight of zero to the first capsule polar pattern generated by the first microphone capsule 206 and a weight of 1.0 to the second capsule polar pattern generated by the second microphone capsule 208.

FIG. 2C is a schematic perspective view of a microphone assembly 200 with three microphone capsules each facing in one of two perpendicular directions. As shown In FIG. 2C, the microphone assembly 200 includes a first microphone capsule 216 disposed on a second microphone capsule 218. The first and second microphone capsules 216, 218 are each facing in a first direction, such as the direction in which the front face 108 is facing. The microphone assembly 200 also includes a third microphone capsule 220 facing in a second direction that is perpendicular to the first direction. The first microphone capsule 216 includes a front face 216-1 and a backside 216-2; the second microphone capsule 218 includes a front face 218-1 and a backside 218-2; and the third microphone capsule 220 includes a front face 220-1 and a backside 220-2. The first microphone capsule 216 generates a first capsule polar pattern, the second microphone capsule 218 generates a second capsule polar pattern, and the third microphone capsule 220 generates a third capsule polar pattern. As explained above, it has been found that by weighting and summing the first, second, and third capsule polar patterns, many different polar patterns can be formed for the microphone assembly 200.

FIG. 2D is a schematic perspective view of a microphone assembly 200 with four microphone capsules each facing in one of two perpendicular directions. As shown in FIG. 2D, the microphone assembly 200 includes a first microphone capsule 238 facing in a first direction, a second microphone capsule 240 facing in the first direction, a third microphone capsule 242 facing in a second direction that is perpendicular to the first direction, and a fourth microphone capsule 244 facing in the second direction. The first microphone capsule 238 includes a front face 238-1 and a backside 238-2; the second microphone capsule 240 includes a front face 240-1 and a backside (not shown); the third microphone capsule 242 includes a front face 242-1 and a backside 242-2; and the fourth microphone capsule 244 includes a front face 244-1 and a backside (not shown). The first microphone capsule 238 generates a first capsule polar pattern, the second microphone capsule 240 generates a second capsule polar pattern, the third microphone capsule 242 generates a third capsule polar pattern, and the fourth microphone capsule 244 generates a fourth capsule polar pattern. As described above, it has been found that by weighting and summing the first, second, third, and fourth capsule polar patterns, many different polar patterns can be formed for the microphone assembly 200.

FIG. 2E is a schematic perspective view of a microphone assembly 200 with four microphone capsules each facing in one of two opposite directions. As shown in FIG. 2E, the microphone assembly 200 includes a first microphone capsule 230 facing in a first direction. The first microphone capsule 230 is disposed on a second microphone capsule 232 that is facing in a second direction and the second direction is opposite the first direction. The microphone assembly 200 further includes a third microphone capsule 234 that is also facing in the first direction and a fourth microphone capsule 236 that is also facing in the second direction. The first microphone capsule 230 includes a front face 230-1 and a backside 230-2; the second microphone capsule 232 includes a front face 232-1 and a backside 232-2; the third microphone capsule 234 includes a front face 234-1 and a backside 234-2; and the fourth microphone capsule 236 includes a front face 236-1 and a backside 236-2. The first microphone capsule 230 generates a first capsule polar pattern, the second microphone capsule 232 generates a second capsule polar pattern, the third microphone capsule 234 generates a third capsule polar pattern, and the fourth microphone capsule 238 generates a fourth capsule polar pattern. As discussed above, it has been found that by weighting and summing the first, second, third, and fourth capsule polar patterns, many different polar patterns can be formed for the microphone assembly 200.

FIG. 2F is a schematic perspective view of a microphone assembly 200 with four microphone capsules each facing in a different direction. As shown, the microphone assembly 200 includes a first microphone capsule 250 facing in a first direction, a second microphone capsule 248 facing in a second direction that is opposite the first direction, a third microphone capsule 252 facing in a third direction, and a fourth microphone capsule 254 facing in a fourth direction that is opposite the third direction. In some embodiments, the third and fourth directions are perpendicular to the first and second directions. The first microphone capsule 250 includes a front face 250-1 and a backside 250-2; the second microphone capsule 248 includes a front face 248-1 and a backside 248-2; the third microphone capsule 252 includes a front face 252-1 and a backside 252-2; and the fourth microphone capsule 254 includes a front face 254-1 and a backside 254-2. The first microphone capsule 248 generates a first capsule polar pattern, the second microphone capsule 250 generates a second capsule polar pattern, the third microphone capsule 252 generates a third capsule polar pattern, and the fourth microphone capsule 254 generates a fourth capsule polar pattern. As explained above, it has been found that by weighting and summing the first, second, third, and fourth capsule polar patterns, many different polar patterns can be formed for the microphone assembly 200.

### Control System Example

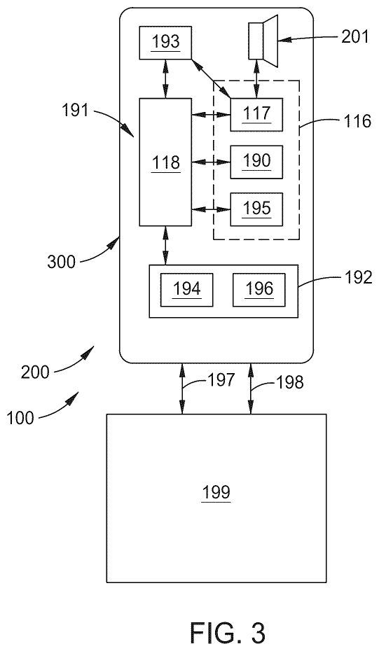

FIG. 3 is a schematic diagram illustrating a control system 300 that includes an electronic assembly 191 within the microphone system 100, according to one embodiment of the present disclosure. In general, the electronic assembly 191 will include a processor 118, non-volatile memory 192, power source 193 and an audible signal processing device 117. During operation, the microphone system 100 is configured to receive a plurality of audible signals from a plurality of microphone capsules within the capsule assembly 201 of a microphone assembly 200. The audible signal processing device 117 and processor 118 then receive audible signal data (e.g., analog signal generated by each of the capsules) generated from the detected audible signals received by each of the microphone capsules and processes the detected inputs to generate a processed audio signal that provided to an external device, perform desired sound capturing activities, and/or one or more useful functions described herein. The processed audio signal(s) can then be used to perform some additional task by the microphone system 100 or other downstream devices, such as the external electronic device.

In some embodiments, the audible signal processing device 117 includes electrical components that can efficiently separate a desired portion of an audible signal from other received noise using one or more signal processing techniques. It is believed that the processes performed by the audible signal processing device 117 can be used to reduce the error rate encountered when using the generated processed audio signal in a subsequent voice detection, voice communication, voice-activated electronic device control and/or voice recognition process versus processed audible signals generated by conventional noise cancelling or noise reduction techniques that are common today.

The electronic assembly 191 may include the processor 118 that is coupled to input/output (I/O) devices 116, the power source 193, and the non-volatile memory unit 192. Memory unit 192 may include one or more software applications 194, such as the controlling software program (i.e., algorithm). The memory unit 192 may also include stored media data 196 that is used by the processor 118 to perform various parts of the methods described herein. The processor 118 may be a hardware unit or combination of hardware units capable of executing software applications and processing data. In some configurations, the processor 118 includes a central processing unit (CPU), a digital signal processor (DSP), an application-specific integrated circuit (ASIC), and/or a combination of such units. The processor 118 is generally configured to execute the one or more software applications 194 and process the stored media data 196, which may be each included within the memory unit 192.

Herein, the memory unit 192 is in the form of a computer-readable storage media containing instructions (e.g., non-volatile memory), that when executed by the CPU, facilitates the operation of the microphone system 100. Instructions stored in the memory unit 192 can be in the form of a program product, such as a program or algorithm (e.g., software applications 194), which when implemented causes one or more of the methods, or portions of the methods, of the present disclosure (e.g., middleware application, equipment software application, etc.) to be performed.

The I/O devices 116 are coupled to memory unit 192 and processor 118, and may include devices capable of receiving input and/or devices capable of providing output. The I/O devices 116 may also include one or more wireless transceivers 190 that are configured to establish one or more different types of wired or wireless communication links with other transceivers residing within other computing devices. A given transceiver within the I/O devices 116 could establish, for example, a Wi-Fi communication link, near field communication (NFC) link or a Bluetooth® communication link (e.g., BTLE, Bluetooth classic), among other types of communication links with similar components in an external electronic device. In some embodiments, electronic components within the I/O device 116 are adapted to transmit signals processed by the audible signal processing device 117 to other internal electronic components found within the microphone system 100 and/or to electronic devices that are external to the microphone system 100.

In some embodiments, the I/O devices 116 include at least one of an XLR communication link and a USB communication link, or both, that is used to communicate with various electrical components coupled to the microphone system 100. As discussed above the electrical components can include an external electronic device that can include a laptop, a desktop computer, video conferencing equipment, a tablet, smartphone or other useful electronic device. In some embodiments, the microphone system 100 is configured to output a processed audio signal in an analog format over the XLR communication link 197 with an external device and have a separate digital communication link 198 (e.g., USB, wireless, etc.) that is configured to transfer digital information through the separate data channel. In one example, as will be discussed further below, detected user proximity data can be transferred within metadata within one or more data streams to an external electronic device 199 for processing via a separate data channel (e.g., USB channel). The separate data channel from the audible signal delivery channel (e.g., XLR or digital communication links) can allow for messages based on a user's interaction with the microphone assembly to be transmitted at desired intervals or times. In one example, a digital signal can include information such data containing statements (e.g.,“I'll be right back”) relating to a user's state of interaction with the microphone system 100, the microphone system's status (e.g., microphone has been muted), or other useful information may be provided.

In some embodiments, the electronic assembly 191 includes an audio processing device 195 that is configured to receive an input signal from the audible signal processing device 117, perform one or more equalization (EQ) activities (e.g., adjust the volume level of a frequency (or range of frequencies) within a sound), and produce an output signal which may then be delivered to the one or more wireless transceivers 190, one or more wired connections (e.g., USB and/or XLR communication links), and/or broadcast by a connected speaker system (not shown). In some embodiments, the electronic assembly 191 is also configured to perform one or more of the following actions: compression, microphone limiting, automatic gain control (AGC), dynamic EQ like de-essing and de-popping, and both machine learning based and traditional signal processing based denoising and noise suppression.

The memory unit 122 may be any technically feasible type of hardware unit configured to store data. For example, the memory unit 122 could be a hard disk, a random access memory (RAM) module, a flash memory unit, or a combination of different hardware units configured to store data. The software application 194, which is stored within the memory unit 192, includes program code that may be executed by processor 118 in order to perform various functionalities and methods associated with the use of the microphone system 100. The stored media data 196 may include any type of information that relates to a desired control parameter (e.g., threshold values), orientation and direction information, calculated time delay information, noise signal RMS information, user data, electronic device configuration data, device control rules, or other useful information, for example. The stored media data 196 may include information that is delivered to and/or received from the source or another electronic device, such as the external electronic device 199. The stored media data 196 may reflect various data files, settings and/or parameters associated with the environment, audible signal processing device control and/or desired behavior of the microphone system 100.

In some embodiments, one or more algorithms running on an external device are used to control and adjust one or more characteristics of the microphone system 100 by use of signals provided via the XLR communication link 197 and/or digital communication link 198. In some cases, the external electronic device 199 includes a user interface (e.g., GUI) that includes various features that are adapted to receive and display information received from the microphone system 100 and adapted to control one or more characteristics of the microphone system 100.

### Visual Display System Examples

FIGS. 4-12 each include a plan view of the visual display system 120 which includes an array of display elements 450 that are configured to represent microphone system 100 status information and/or one or more attributes of a polar pattern generated by a combination of one or more capsule polar patterns by use of the components in the capsule assembly 201 and the electronic assembly 191 of the microphone system 100. In one example, as shown in FIGS. 4-12, the visual display system 120 includes 24 display elements 450 that are configured in a circular array about a central axis 451 of the body 104 of the microphone system 100. The display elements 450 each include a light emitting element, such as a LED that is capable of generating one or more visible wavelengths of light at different light intensity levels. In one example, each display element 450 includes an RGB type of LED configured to generate red, green, and blue wavelengths of light, and combinations thereof. For discussion purposes, it is assumed that the representation of the visual display system 120 illustrated in FIGS. 4-12 is formed by use of a sectioning line or plane that is parallel to the horizontal plane (i.e., X-Y plane) and thus the representation of the attributes of a polar pattern can be seen by users as they traverse around the central axis 451 of stationary body 104 of the microphone system 100. One skilled in the art will appreciate that the polar pattern generated by use of the capsule assembly 201 is able to preferentially alter collected audible signals received in many different directions that are not within or limited to directions within a horizontal plane, and will include a vertical direction (e.g., +Z and −Z directions).

In FIGS. 4-12, the represented size of the hatched regions and the type of hatch used in each region within a display element 450 is used to illustrate the intensity of the light emitted by the display element 450 and the color of the light emitted by the display element 450, respectively. In some embodiments, a color of the light emitted by each of display elements 450 within the visual display system 120 can be controlled by the control system 300 to provide information to a user regarding the type polar pattern that is currently being used by the microphone system 100, characteristics of the polar pattern, the alignment or orientation of the polar pattern relative to features of the microphone system 100 (e.g., front face 108), and/or arrival directions of audible signals received from one or more audible sources. In one example, as illustrated in FIG. 4, the visual indications 420, 421 and 422 formed within 12 different display elements 450, which include a dark hatched pattern, include the generation of a first color of light (e.g., green wavelengths of light) and the visual indications 430, 431 and 432 formed within 12 different display elements 450, which include a lighter hatched pattern (e.g., box hatch), include the generation of a second color of light (e.g., red wavelengths of light) that are both used to represent a first characteristic of a generated polar pattern. The visual indications 420, 421 and 422 and the visual indications 430, 431 and 432 formed within the display elements 450 also include hatched regions of differing sizes that are each used to represent a second characteristic of a generated polar pattern, such as intensity of the light generated by the display elements 450. In one example, the intensity of the light generated by the display elements 450 within the visual indications 420, 421 and 422 and the visual indications 430, 431 and 432 decrease in intensity as the size of the hatched region decreases. In one example, the representation of light intensity represented by visual indication 420 is greater than the intensity of the visual indication 421, and the intensity of visual indication 421 is greater than the intensity of the visual indication 422. In yet another example, the differing size of the visual indications can also indicate a difference in the shade of the color generated by the display elements. In one example, the successively positioned display elements 450 in the array of display elements 450 can include a shift in a displayed color, such as a progressively darkening shade of green across multiple display elements 450.

FIG. 4 is a plan view of the visual display system 120 which is intended to schematically represent a display of a figure eight polar pattern 402 by the display elements 450 of the visual display system 120. As shown in FIG. 4, for ease of discussion reasons, a representation of the figure eight polar pattern 402 displayed by the visual display system 120 is oriented and positioned within a central location within the visual display system 120 illustration. The microphone assembly 200, having the figure eight polar pattern 402, can be advantageously used to capture sounds from sources, such as users 410 and 414, that are positioned in the front (0°) and the back (180°) of the microphone assembly 200. The orientation of the microphone assembly 200 and the use of the figure eight polar pattern 402 can be useful for recording interviews or vocal duets using a single microphone assembly.

Notably, the figure eight polar pattern 402 can be formed for the microphone assembly 200 using multiple different microphone capsule configurations. As described above with reference to FIG. 2A, the figure eight polar pattern 402 can be formed using the first and second audible signals generated respectively by the first and second microphone capsules 202, 204 (that are both cardioid microphone capsules) by subtracting the second audible signal from the first audible signal. As described with respect to FIG. 2B, the figure eight polar pattern 402 may be formed by applying a weight of 1.0 to the first audible signal generated by the first microphone capsule 206 (e.g., the figure eight microphone capsule) and a weight of zero to the second audible signal generated by the second microphone capsule 208 (e.g., the omnidirectional microphone capsule). Although two examples are briefly described, it is to be appreciated that the figure eight polar pattern 402 can be formed by weighting and summing audible signals generated by many different types and numbers of microphone capsules arranged in various configurations.

A microphone assembly 200 that is configured to generate a figure eight polar pattern 402 oriented in a zero degree orientation is sensitive to sounds arriving from the front (0°) and the back (180°) and insensitive to sounds arriving from the sides (90° and 270°). The figure eight polar pattern 402 includes nodes (also called lobes) at the front (0°) and the back (180°) that are locations at which the corresponding microphone assembly 200 captures arriving sounds (e.g., acoustic waves) with high fidelity. The figure eight polar pattern 402 also includes nulls at the left side (90°) and the right side (270°) that are locations at which the corresponding microphone assembly 200 rejects or attenuates the arriving sounds. As described above, in order to indicate the locations of the nodes and the nulls of the figure eight polar pattern 402, the visual display system 120 is configured to display a representation of a generated figure eight polar pattern 402 by the capsule assembly 201 of the microphone assembly 200.

As shown in FIG. 4, the representation of the figure eight polar pattern 402 includes visual indications 420 displayed at the front (0°) and the back (180°) of the visual display system 120. For example, the visual indications 420 may be displayed by corresponding light emitting diodes (LEDs) of the visual display system 120. In one or more embodiments, the visual indications 420 include one or more visual characteristics that correspond to characteristics of the figure eight polar pattern 402. Similarly, visual indications 421 and visual indications 422 are displayed by display elements 450 that are at incremental polar angular orientations extending away from the 0° and 180° degree directions, such as 15° increments which is set by the position and number of the display elements 450 found in the array of display elements 450 within the visual display system 120. The decrease in size of the visual indications as they extend away from the front (0°) and the back (180°) orientation can be used to illustrate to the users 410, 414 the decreasing sensitivity of the microphone assembly 200 to incoming sounds at these off-angles due to the shape of the generated polar pattern. In some embodiments, the visual indications 420, 421, and 422 include visual features of a first color (e.g., a first wavelength of light) and intensity (e.g., a first brightness of light). As discussed above, the intensity of the first color may visually indicate the relative sensitivity to sounds arriving at the front (0°) and the back (180°) orientations of the visual display system 120.

A representation of the figure eight polar pattern 402 by the visual display system 120 can include visual indications 430 displayed at a first side (90°) and a second side (270°) of the visual display system 120. In one or more embodiments, the visual indications 430 include one or more visual characteristics that correspond to characteristics of null regions formed in the figure eight polar pattern 402. Similarly, visual indications 431 and third visual indications 432 are displayed by display elements 450 that are at incremental polar angular orientations extending away from the first side (90°) and the second side (270°), such as 15° increments within the visual display system 120. The decrease in size of the visual indications as they extend away from the first side (90°) and the second side (270°) orientation can be used to illustrate to the users 410, 414 or others positioned in the null positions the decreasing attenuation (or increasing sensitivity) of the microphone assembly 200 to incoming sounds in side orientations due to the shape of the generated polar pattern. In some embodiments, the visual indications 430, 431, and 432 include visual features of a second color (e.g., a second wavelength of light) and intensity. As discussed above, the intensity of the second color may visually indicate the relative insensitivity to sounds arriving at the first side (90°) and the second side (270°) orientations of the visual display system 120. In one or more examples, a greater intensity of the second color may correspond to a greater insensitivity to the sounds received within these side directions.

Consider examples in which the visual display system 120 displays the representation of the figure eight polar pattern 402 for the microphone assembly 200 such that the user 410 can cause sounds that are desirable to capture to arrive at the visual indications 420. For example, user 410 may adjust the orientation of the microphone assembly 200 such that the sounds arrive at the visual indication 420 locations. Similarly, the user 410 may leverage the representation of the figure eight polar pattern 402 to cause sounds that are not desirable to capture (e.g., noise) to primarily arrive at the microphone assembly 200 at the visual indications 430 location. The visual indications 430, 431, 432 are also referred to herein as the null visual indications 430, 431, 432. In various examples, the user 410 can adjust the orientation of the microphone assembly 200 or orientation of the polar pattern generated by the control system 300 such that noise arrives at the null visual indications 430.

As described further below, it is to be appreciated that, in some embodiments, rather than adjusting the physical orientation of the microphone assembly 200, the user 410 can interact with one or more user interface elements to adjust the angular orientation of the polar pattern formed for the microphone assembly 200. The one or more user interface elements can include the switch 110 or display device 140 of the microphone assembly 200. In one example, adjusting a knob or GUI element is used to adjust the horizontal angular orientation of the polar pattern so that the orientation is at an angle that is different from being oriented towards the front (0°) orientation. In some embodiments, commands provided from an external electronic device 199 can be used to adjust one or more characteristics of a generated polar pattern, such as the horizontal angular orientation of the polar pattern. Once the polar pattern has been adjusted, desirable audible signals are oriented or positioned to arrive at the node related visual indications (e.g., such as the visual indications 420) and undesirable audible signals (noise) arrive at null visual indications (e.g., null visual indications 430). It is to be further appreciated that, in various embodiments, the polar pattern formed for the microphone assembly 200 can be automatically adjusted by use of a controlling algorithm running within the control system 300 such that desirable sounds primarily arrive at first node visual indications and undesirable sound (noise) primarily arrive at the first null visual indications.

In various embodiments, one or more sensors of the sensor system 130 can detect whether a particular audible signal is a desirable audible signal to be captured or an undesirable audible signal (e.g., noise) to be rejected or attenuated. As outlined below, if the particular audible signal is to be captured, then the polar pattern formed for the microphone assembly 200 can be automatically adjusted to co-locate a node with an arrival location of the particular audible signal. If the particular audible signal is to be rejected, then the polar pattern formed for the microphone assembly 200 can be automatically adjusted to co-locate a null with the arrival location of the particular audible signal.

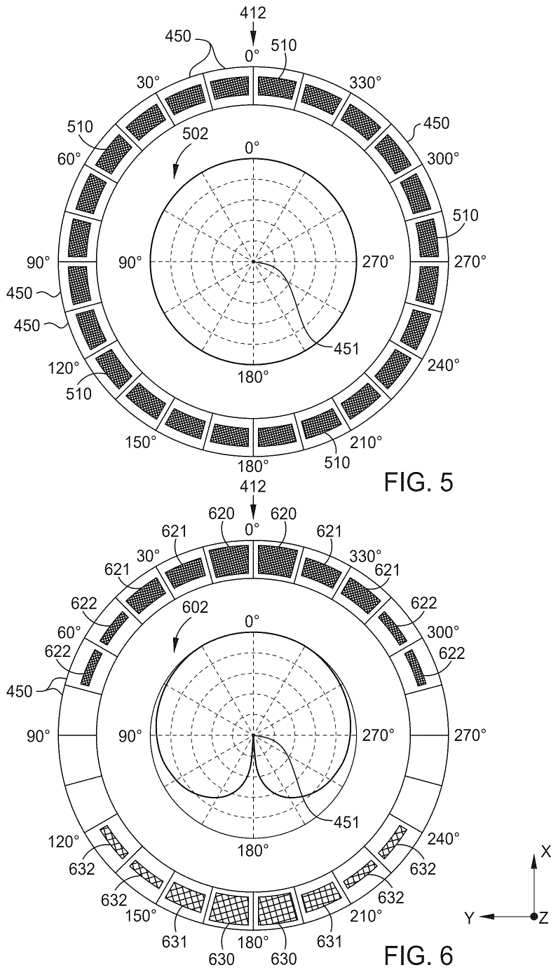

FIG. 5 is a plan view of the visual display system 120 which is intended to schematically represent a display of an omnidirectional polar pattern 502 by the display elements 450 of the visual display system 120. As shown, a microphone assembly 200 having the omnidirectional polar pattern 502 is equally sensitive to sounds regardless of arrival directions of the sounds. Accordingly, the generation of an omnidirectional polar pattern 502 by the microphone assembly 200 may be advantageously used for group recordings with many sounds arriving in many directions such as a choir or an orchestra. The audible signal arrival direction 412, which represents the user 410, is oriented to face towards the front (0°) of the omnidirectional polar pattern 502. The representation of the omnidirectional polar pattern 502, as shown in FIG. 5, includes visual indications 510 displayed around the visual display system 120. The visual indications 510 may be displayed by LEDs of the visual display system 120. In one or more embodiments, the visual indications 510 include one or more visual features that correspond to properties/characteristics of the omnidirectional polar pattern 502. In some embodiments, the visual indications 510 include visual features that include a color and an intensity. Since the omnidirectional polar pattern 502 is equally sensitive to sounds regardless of arrival directions of the sounds, the indications 510 each have the same color and the same intensity. For example, the indications 510 inform the user 410 that adjusting an orientation of the microphone assembly 200 having the omnidirectional polar pattern 502 should not significantly affect sound capture/rejection. As with any of the polar patterns that can be used and/or generated by the microphone assembly 200, the display elements 450 can be configured to generate visual indications 510 that is a specific selected color that is different from a color that is used to represent other polar patterns that are generated by the microphone assembly 200.

FIG. 6 is a plan view of the visual display system 120 which is intended to schematically represent a display of a cardioid polar pattern 602 by the display elements 450 of the visual display system 120. The cardioid polar pattern 602 is commonly used because it is directionally sensitive to sounds arriving from the front (0°) of a microphone assembly 200. The cardioid polar pattern 602 also attenuates sounds arriving from the back (180°) and the sides (90° and 270°) of the microphone assembly 200. Accordingly, the microphone assembly 200 having the cardioid polar pattern 602 is sensitive to sounds arriving from the front, for example, sounds arriving between angles about 75° and about 285°. In various embodiments, the microphone assembly 200 having the cardioid polar pattern 602 is advantageously used to collect sound from sources that are primarily positioned in the direction 412 relative to the microphone assembly 200 such as for recording solo vocals, single instruments, academic lectures provided from a professor, and presentations given by one presenter at a time.

The representation of the cardioid polar pattern 602 includes first visual indications 620 displayed at the front (0°) of the visual display system 120. In one or more embodiments, the first visual indications 620 can be displayed by corresponding LEDs of the visual display system 120. The first visual indications 620 include one or more visual features that correspond to properties and characteristics of the cardioid polar pattern 602. In some embodiments, the first visual indications 620 include visual features of a first color (e.g., a first wavelength of light) and a first intensity (e.g., a first brightness of light). The first color indicates that locations of the first visual indications 620 correspond to locations of nodes (e.g., rather than nulls) and the first intensity indicates relative sensitivity to sounds arriving at the locations of the first visual indications 620.

The representation of the cardioid polar pattern 602 also includes visual indications 621 and 622. In some embodiments, these visual indications 621 and 622 may be displayed by corresponding LEDs of the visual display system 120. In one or more examples, the visual indications 621 include visual features of the first color (e.g., the first wavelength of light) and a second intensity (e.g., a second brightness of light). In various embodiments, the first intensity of the first visual indications 620 may be greater than the second intensity of the second visual indications 621 due to, in this example, the sound being received by the microphone assembly 200 primarily in the direction 412. Accordingly, in these embodiments, locations of the first visual indications 620 are more sensitive to arriving sounds than locations of the second visual indications 621. As shown, the third visual indications 622 include visual features of the first color (e.g., the first wavelength of light) and a third intensity (e.g., a third brightness of light). The first color indicates that locations of the third visual indications 622 correspond to locations of nodes (e.g., rather than nulls) of the cardioid polar pattern 602. The third intensity indicates relative sensitivity to sounds arriving at the locations of the third visual indications 622. In some examples, the second intensity of the second visual indications 621 may be greater than the third intensity of the third visual indications 622. In these examples, the locations of the second visual indications 621 are more sensitive to arriving sounds than locations of the third visual indications 622.

In FIG. 6, the representation of the cardioid polar pattern 602 includes first null visual indications 630 displayed at the back (180°) of the visual display system 120. In some embodiments, the first null visual indications 630 are displayed by the display elements 450. The first null visual indications 630 include one or more visual features that correspond to properties and characteristics of the cardioid polar pattern 602. In one or more embodiments, the first null visual indications 430 include visual features of a second color (e.g., a second wavelength of light) and a first intensity (e.g., a first brightness of light). In various examples, the second color may indicate that locations of the first null visual indications 630 correspond to locations of nulls (e.g., rather than nodes) of the cardioid polar pattern 602. The first intensity of the second color may visually indicate relative insensitivity to the audible signals arriving at the locations of the first null visual indications 630. In one or more examples, a greater intensity of the second color may correspond to a greater insensitivity to the audible signals. Second and third null visual indications 631, 632 are also included in representation of the cardioid polar pattern 602. In some embodiments, the second and third null visual indications 631, 632 may be displayed by corresponding the display elements 450. The second null visual indications 631 include visual features of the second color (e.g., the second wavelength of light) and a second intensity (e.g., a second brightness of light). In an example, the first intensity of the first null visual indications 630 may be greater than the second intensity of the second null visual indications 631. In this example, locations of the first null visual indications 630 may be more insensitive (less sensitive) to arriving sounds than locations of the second null visual indications 631. In one or more embodiments, the third null visual indications 632 include visual features of the second color (e.g., the second wavelength of light) and a third intensity (e.g., a third brightness of light). In various examples, the second intensity of the second null visual indications 631 is greater than the third intensity of the third null visual indications 632. In these examples, the locations of the second null visual indications 631 may be more insensitive to arriving sounds than locations of the third null visual indications 632.

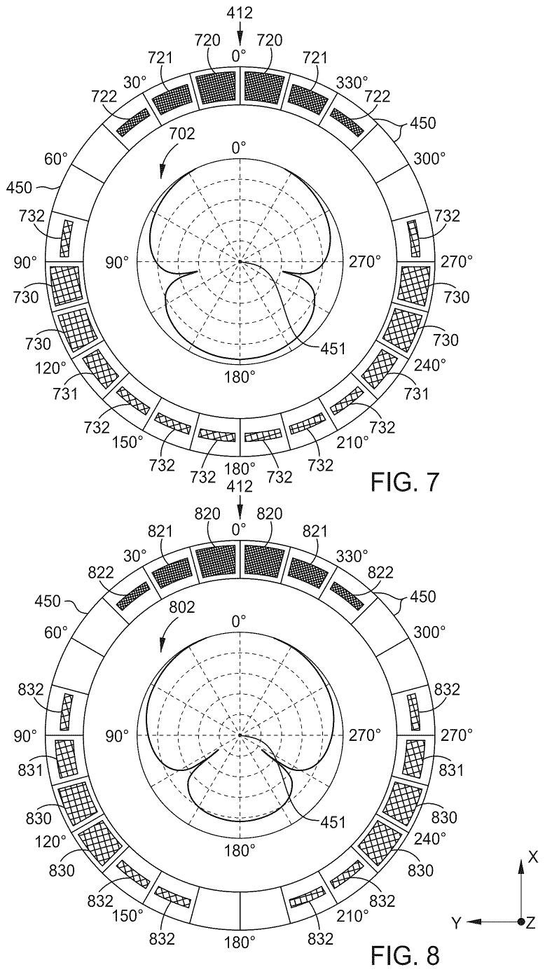

FIG. 7 is a plan view of the visual display system 120 which is intended to schematically represent a display of a hypercardioid polar pattern 702 by the display elements 450 of the visual display system 120. In general, the hypercardioid polar pattern 702 has a narrower range of sensitivity to sounds arriving from the front (0°) and a greater insensitivity to sounds arriving from the sides (90° and 270°) than the cardioid polar pattern 602. One will note that the separation distance in the radial direction between dashed concentric circles shown in FIGS. 4-12 relates to a fixed amount of attenuation, such as a 6 dB attenuation per radial directional step between adjacent dashed concentric circles. The hypercardioid polar pattern 702 also has greater insensitivity to sounds arriving from the back (180°) than the figure eight polar pattern 402. As shown, a microphone assembly 200 having the hypercardioid polar pattern 702 is sensitive to sounds arriving from the very front (between about 45° and about 315°) and insensitive to sounds arriving from the back (180°), the left side (about 105°), and the right side (about 255°). The microphone assembly 200 having the hypercardioid polar pattern 702 can be advantageously used to collect sound from sources that are primarily positioned in the direction 412 relative to the microphone assembly 200 such as for broadcasting, film and video production, and recording live performances (e.g., to isolate sounds from instruments and/or vocalists and reduce sounds from a stage or audience).

As shown in FIG. 7, the representation of the hypercardioid polar pattern 702 displayed by the visual display system 120 includes first, second, and third visual indications 720, 721, 722. For example, the first visual indications 720 are displayed at the front (0°) of the visual display system 120. In some embodiments, the first, second, and third visual indications 720, 721, 722 are displayed by corresponding display elements 450 of the visual display system 120. The first, second, and third visual indications 720, 721, 722 each include visual features of a first color that indicates locations of the first, second, and third visual indications 720, 721, 722 correspond to nodes (e.g., rather than nulls) of the hypercardioid polar pattern 702. The first, second, and third visual indications 720, 721, 722 also include visual features of first, second, and third intensities of the first color, respectively. In some embodiments, the first, second, and third intensities of the first color indicate relative sensitivity to sounds arriving at locations of the first, second, and third visual indications 720, 721, 722, respectively. In one or more embodiments, the first intensity of the first visual indications 720 is greater than the second intensity of the second visual indications 721. The second intensity of the second visual indications 721 may be greater than the third intensity of the third visual indications 722.

The representation of the hypercardioid polar pattern 702 also includes first, second, and third null visual indications 730, 731, 732. As shown, the first null visual indications 730 are displayed at the left side (about 105°) and at the right side (about 255°) of the visual display system 120. The first, second, and third null visual indications 730, 731, 732 may be displayed by corresponding display elements 450 of the visual display system 120. In one or more embodiments, the first, second, and third null visual indications 730, 731, 732 each include visual features of a second color that indicates locations of the first, second, and third null visual indications 730, 731, 732 correspond to nulls (e.g., rather than nodes) of the hypercardioid polar pattern 702. Similar to the first, second, and third visual indications 720, 721, 722 relative to the first color, the first, second, and third null visual indications 730, 731, 732 include visual features of first, second, and third intensities of the second color, respectively. In some embodiments, the second intensity of the second null visual indications 731 is greater than the third intensity of the third null visual indications 732. In one or more embodiments, the first intensity of the first null visual indications 730 is greater than the second intensity of the second null visual indications 731.

FIG. 8 is a plan view of the visual display system 120 which is intended to schematically represent a display of a supercardioid polar pattern 802 by the display elements 450 of the visual display system 120. Generally, the supercardioid polar pattern 802 has a similar sensitivity to sounds arriving from the front (0°) and a greater insensitivity to sounds arriving from the back (180°) than the cardioid polar pattern 602. The supercardioid polar pattern 802 also has a greater insensitivity to sounds arriving from the back (180°) than the figure eight polar pattern 402 and the hypercardioid polar pattern 702. A microphone assembly 200 having the supercardioid polar pattern 802 is sensitive to sounds arriving from the front (between about 45° and about 315°) and insensitive to sounds arriving from the back (180°) and the sides (90° and 270°). The microphone assembly 200 having the supercardioid polar pattern 802 may be advantageously used for recording podium speeches and individual instruments.

With reference to FIG. 8, the representation of the supercardioid polar pattern 802 is displayed by the visual display system 120 and includes first, second, and third visual indications 820, 821, 822. The first visual indications 820 are displayed at the front (0°) of the visual display system 120, due to the arrival of sound from the direction 412. In various embodiments, the first, second, and third visual indications 820, 821, 822 are displayed by corresponding display elements 450 of the visual display system 120. In some embodiments, the first, second, and third visual indications 820, 821, 822 each include visual features of a first color that indicates locations of the first, second, and third visual indications 820, 821, 822 correspond to nodes (e.g., rather than nulls) of the supercardioid polar pattern 802. In these embodiments, the first, second, and third visual indications 820, 821, 822 can include visual features of first, second, and third intensities of the first color, respectively. The first, second, and third intensities of the first color may indicate relative sensitivity to sounds arriving at locations of the first, second, and third visual indications 820, 821, 822, respectively. In one or more examples, the first intensity of the first visual indications 820 is greater than the second intensity of the second visual indications 821. In these examples, the second intensity of the second visual indications 821 can be greater than the third intensity of the third visual indications 822.

The representation of the supercardioid polar pattern 802 displayed by the visual display system 120 also includes first, second, and third null visual indications 830, 831, 832. The first null visual indications 830 are displayed at the left side (120°) and at the right side (240°) of the visual display system 120. In some embodiments, the first, second, and third null visual indications 830, 831, 832 are displayed by corresponding display elements 450 of the visual display system 120. In various embodiments, the first, second, and third null visual indications 830, 831, 832 each include visual features of a second color that indicates locations of the first, second, and third null visual indications 830, 831, 832 correspond to nulls (e.g., rather than nodes) of the supercardioid polar pattern 802. The first, second, and third null visual indications 830, 831, 832 may include visual features of first, second, and third intensities of the second color, respectively. In one or more embodiments, the second intensity of the second null visual indications 831 is greater than the third intensity of the third null visual indications 832. In certain embodiments, the first intensity of the first null visual indications 830 is greater than the second intensity of the second null visual indications 831.

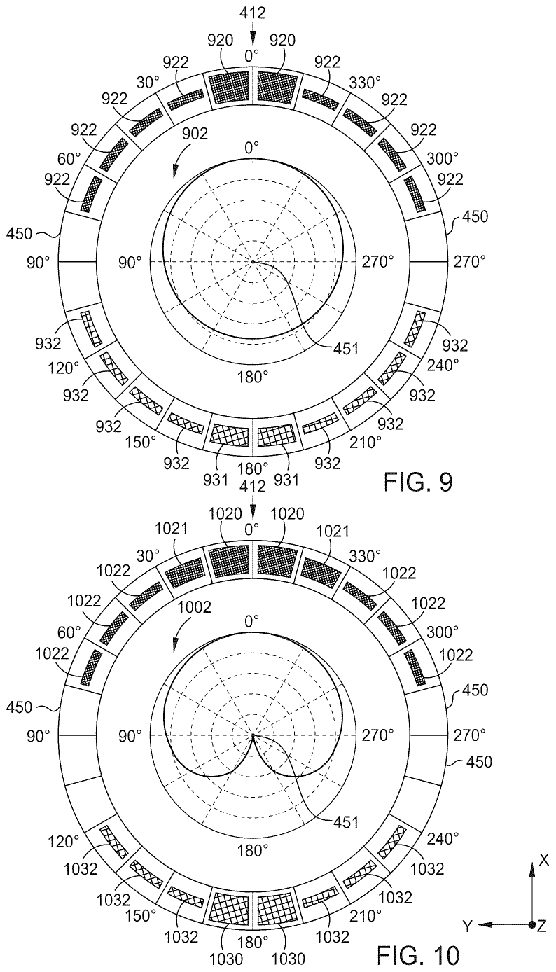

FIG. 9 is a plan view of the visual display system 120 which is intended to schematically represent a display of a subcardioid polar pattern 902 by the display elements 450 of the visual display system 120. The subcardioid polar pattern 902 has less sensitivity to sounds arriving from the back (180°) than the omnidirectional polar pattern 502. However, the subcardioid polar pattern 902 has more sensitivity to sounds arriving from the back (180°) than the cardioid polar pattern 602. The subcardioid polar pattern 902 has similar sensitivity to sounds arriving from the front (0°) as the cardioid polar pattern 602. In some embodiments, a microphone assembly 200 having the subcardioid polar pattern 902 may be advantageously used for recording multiple singers in a theater production or wildlife sounds received from a broad number of sources.

The representation of the subcardioid polar pattern 902 includes first and second visual indications 920, 922. The first visual indications 920 are displayed at the front (0°) of the visual display system 120. In some embodiments, the first and second visual indications 920, 922 are displayed by corresponding display elements 450 of the visual display system 120. The first and second visual indications 920, 922 each include visual features of a first color that indicates locations of the first and second visual indications 920, 922 correspond to nodes (e.g., rather than nulls) of the subcardioid polar pattern 902. In one or more embodiments, the first and second visual indications 920, 922 can include visual features of first and second intensities of the first color, respectively. The first and second intensities of the first color may indicate relative sensitivity to sounds arriving at locations of the first and second visual indications 920, 922, respectively. In some embodiments, the first intensity of the first visual indications 920 is greater than the second intensity of the second visual indications 922.

As shown in FIG. 9, the representation of the subcardioid polar pattern 902 also includes first and second null visual indications 931, 932. The first null visual indications 931 are displayed at the back (180°) of the visual display system 120. In some embodiments, the first and second null visual indications 931, 932 are displayed by corresponding display elements 450 of the visual display system 120. In various embodiments, the first and second null visual indications 931, 932 each include visual features of a second color that indicates locations of the first and second null visual indications 931, 932 correspond to nulls (e.g., rather than nodes) of the subcardioid polar pattern 902. The first and second null visual indications 931, 932 may include visual features of first and second intensities of the second color, respectively. In certain embodiments, the first intensity of the first null visual indications 931 is greater than the second intensity of the second null visual indications 932.

FIG. 10 is a plan view of the visual display system 120, which is intended to schematically represent a display of a second-order cardioid polar pattern 1002 by the display elements 450 of the visual display system 120. In some embodiments, forming second order polar patterns for the microphone system 100 that can be formed by various processing techniques, which can include adjusting the weights of combined capsule polar patterns generated by different microphone capsules, and/or incorporating delays and/or phase shifting the generated signals received from the microphones. The second order cardioid polar pattern 1002 has a narrower range of sensitivity to sounds arriving from the front (0°) than the cardioid polar pattern 602. As shown, the second order cardioid polar pattern 1002 also has a greater range of insensitivity to sounds arriving from the back (180°) and the sides (90° and 270°) than the cardioid polar pattern 602. In some embodiments, a microphone assembly 200 having the second order cardioid polar pattern 1002 may be advantageously used to capture sound from sources that are primarily positioned in the direction 412 relative to the microphone assembly 200.

As illustrated in FIG. 10, the representation of the second order cardioid polar pattern 1002 is displayed by the visual display system 120 and includes first, second, and third visual indications 1020, 1021, 1022. The first visual indications 1020 are displayed at the front (0°) of the visual display system 120. In various embodiments, the first, second, and third visual indications 1020, 1021, 1022 are displayed by corresponding display elements 450 of the visual display system 120. In one or more embodiments, the first, second, and third visual indications 1020, 1021, 1022 each include visual features of a first color that indicates locations of the first, second, and third visual indications 1020, 1021, 1022 correspond to nodes (e.g., rather than nulls) of the second order cardioid polar pattern 1002. The first, second, and third visual indications 1020, 1021, 1022 may include visual features of first, second, and third intensities of the first color, respectively. The first, second, and third intensities of the first color can indicate relative sensitivity to sounds arriving at locations of the first, second, and third visual indications 1020, 1021, 1022, respectively. In some examples, the first intensity of the first visual indications 1020 is greater than the second intensity of the second visual indications 1021. In these examples, the second intensity of the second visual indications 1021 is greater than the third intensity of the third visual indications 1022.

The representation of the second order cardioid polar pattern 1002 also includes first and second null visual indications 1030, 1032. The first null visual indications 1030 are displayed at the back (180°) of the visual display system 120 (e.g., by corresponding display elements 450 of the visual display system 120). In various embodiments, the first and second null visual indications 1030, 1032 each include visual features of a second color that indicates locations of the first and second null visual indications 1030, 1032 correspond to nulls (e.g., rather than nodes) of the second order cardioid polar pattern 1002. In some embodiments, the first and second null visual indications 1030, 1032 include visual features of first and second intensities of the second color, respectively. The first intensity of the first null visual indications 1030 may be greater than the second intensity of the second null visual indications 1032.

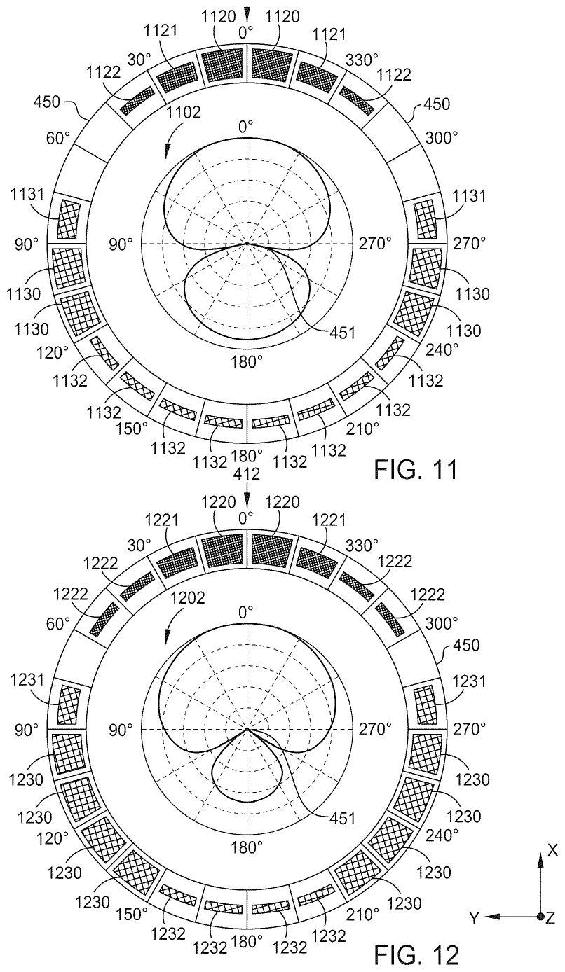

FIG. 11 is a plan view of the visual display system 120 which is intended to schematically represent a display of a second order hypercardioid polar pattern 1102 by the display elements 450 of the visual display system 120. Generally, the second order hypercardioid polar pattern 1102 has a narrower range of sensitivity to sounds arriving from the front (0°) and a greater insensitivity to sounds arriving from the back (180°) and the sides (90° and 270°) than the hypercardioid polar pattern 702. A microphone assembly 200 having the second order hypercardioid polar pattern 1102 is sensitive to sounds arriving from the very front (between about 30° and about 330°) and insensitive to sounds arriving from the back (180°), the left side (about 100°), and the right side (about 260°). The microphone assembly 200 having the second order hypercardioid polar pattern 1102 can be advantageously used to record sound from sources that are primarily positioned in the direction 412 relative to the microphone assembly 200 such as for recording live performances.

In some embodiments, the representation of the second order hypercardioid polar pattern 1102 includes first, second, and third visual indications 1120, 1121, 1122. As shown in FIG. 11, the first visual indications 1120 are displayed at the front (0°) of the visual display system 120. In one or more embodiments, the first, second, and third visual indications 1120, 1121, 1122 are displayed by corresponding display elements 450 of the visual display system 120. The first, second, and third visual indications 1120, 1121, 1122 may each include visual features of a first color that indicates locations of the first, second, and third visual indications 1120, 1121, 1122 correspond to nodes (e.g., rather than nulls) of the second order hypercardioid polar pattern 1102. In various embodiments, the first, second, and third visual indications 1120, 1121, 1122 may include visual features of first, second, and third intensities of the first color, respectively. In these embodiments, the first, second, and third intensities of the first color indicate relative sensitivity to sounds arriving at locations of the first, second, and third visual indications 1120, 1121, 1122, respectively. The first intensity of the first visual indications 1120 may be greater than the second intensity of the second visual indications 1121. In some examples, the second intensity of the second visual indications 1121 is greater than the third intensity of the third visual indications 1122.

With reference to FIG. 11, the representation of the second order hypercardioid polar pattern 1102 also includes first, second, and third null visual indications 1130, 1131, 1132. As shown, the first null visual indications 1130 are displayed at the left side (105°) and at the right side (255°) of the visual display system 120. In some embodiments, the first, second, and third null visual indications 1130, 1131, 1132 are displayed by corresponding display elements 450 of the visual display system 120. In one or more embodiments, the first, second, and third null visual indications 1130, 1131, 1132 each include visual features of a second color that indicates locations of the first, second, and third null visual indications 1130, 1131, 1132 correspond to nulls (e.g., rather than nodes) of the second order hypercardioid polar pattern 1102. The first, second, and third null visual indications 1130, 1131, 1132 may include visual features of first, second, and third intensities of the second color, respectively. The first, second, and third intensities of the second color can indicate relative insensitivity to sounds arriving at locations of the first, second, and third null visual indications 1130, 1131, 1132, respectively. In some examples, the second intensity of the second null visual indications 1131 is greater than the third intensity of the third null visual indications 1132. In these examples, the first intensity of the first null visual indications 1130 is greater than the second intensity of the second null visual indications 1131.

FIG. 12 is a plan view of the visual display system 120 which is intended to schematically represent a display of a second order supercardioid polar pattern 1202 by the display elements 450 of the visual display system 120. In general, the second order supercardioid polar pattern 1202 has a reduced sensitivity to sounds arriving from the front (0°) and a greater insensitivity to sounds arriving from the back (180°) and the sides (90° and 270°) than the supercardioid polar pattern 802. A microphone assembly 200 having the second order supercardioid polar pattern 1202 is sensitive to sounds arriving from the very front (between about 30° and about 330°) and insensitive to sounds arriving from the sides (120° and 240°) and the back (180°). The microphone assembly 200 having the second order supercardioid polar pattern 1202 may be advantageously used for recording individual instruments.

As shown in FIG. 12, the representation of the second order supercardioid polar pattern 1202 includes first, second, and third visual indications 1220, 1221, 1222. As further shown, the first visual indications 1220 are displayed at the front (0°) of the visual display system 120. In some embodiments, the first, second, and third visual indications 1220, 1221, 1222 are displayed by corresponding display elements 450 of the visual display system 120. In one or more embodiments, the first, second, and third visual indications 1220, 1221, 1222 each include visual features of a first color that indicates locations of the first, second, and third visual indications 1220, 1221, 1222 correspond to nodes (e.g., rather than nulls) of the second order supercardioid polar pattern 1202. The first, second, and third visual indications 1220, 1221, 1222 may include visual features of first, second, and third intensities of the first color, respectively. In some embodiments, the first, second, and third intensities of the first color indicate relative sensitivity to sounds arriving at locations of the first, second, and third visual indications 1220, 1221, 1222, respectively. In some examples, the first intensity of the first visual indications 1220 is greater than the second intensity of the second visual indications 1221. In these examples, the second intensity of the second visual indications 1221 is greater than the third intensity of the third visual indications 1222.

In various embodiments, the representation of the second order supercardioid polar pattern 1202 also includes first, second, and third null visual indications 1230, 1231, 1232. In FIG. 12, the first null visual indications 1230 are displayed at the left side (120°) and at the right side (240°) of the visual display system 120. In some embodiments, the first, second, and third null visual indications 1230, 1231, 1232 are displayed by corresponding display elements 450 of the visual display system 120. In one or more embodiments, the first, second, and third null visual indications 1230, 1231, 1232 each include visual features of a second color that indicates locations of the first, second, and third null visual indications 1230, 1231, 1232 correspond to nulls (e.g., rather than nodes) of the second order supercardioid polar pattern 1202. The first, second, and third null visual indications 1230, 1231, 1232 may include visual features of first, second, and third intensities of the second color, respectively. The first, second, and third intensities of the second color can indicate relative insensitivity to sounds arriving at locations of the first, second, and third null visual indications 1230, 1231, 1232, respectively. In some examples, the second intensity of the second null visual indications 1231 is greater than the third intensity of the third null visual indications 1232. In these examples, the first intensity of the first null visual indications 1230 is greater than the second intensity of the second null visual indications 1231.

### User Interaction Examples

FIG. 13 is a plan view of a visual display system 120 which is intended to schematically represent a display of a first visual indication 1304 of first user 410's position relative to the microphone assembly 200. In general, the user's position can be in an ideal user location, such as a user's position along the direction 412, or as shown in FIG. 13 at a position that is not at an ideal user location. In some examples, the ideal user location represents an optimal location for the user 410 to originate sounds to be captured based on a polar pattern formed for the microphone assembly 200 as described further below. In some embodiments, the ideal user location includes a position that is aligned in a direction that is aligned at an optimal node location (e.g., normal to the front face 108 in FIG. 4) and is positioned a desired distance from the microphone assembly 200 (e.g., distance from the front face 108). In some embodiments, the ideal user location can be adjusted to conform to a location that is not aligned with the front face 108. As shown, the user 410 is located in a first location with respect to the microphone assembly 200 and the visual display system 120.

In some embodiments, one or more sensors of the sensor system 130 detect the user 410 is in the first location and also detect that the user is not in the ideal user location as described below. In various embodiments, the sensor system 130 includes a proximity sensor such as, for example, a single-zone proximity sensor having a field-of-view (FOV) that is defined by an acute angle, such as a viewing angle measured in the horizontal plane of less than or equal to 90°. As discussed above, the sensor system 130 can include a multi-zone proximity sensor having a FOV of less than or equal to 90°.

In one or more embodiments, the sensor system 130 detects the first location as being aligned with an angled direction 1302 and the sensor system 130 detects the ideal user location based on the orientation of the capsule assembly 201 and/or alignment of the generated polar pattern as being aligned with the direction 412, which can be associated with the front face 108. The visual display system 120 displays the first visual indications 1304 which may indicate to the user 410 how to relocate to the ideal user location from the first location. For example, the first visual indications 1304 may include instructions, arrows, or other visual indications of how to relocate to the ideal user location. In some embodiments, the user 410 may relocate to the ideal user location based on information provided by the first visual indications 1304. In one example, the first visual indications 1304 can change color (e.g., change from shades of red to shades of green) as the user moves closer to the ideal location which is positioned along the direction 412. In some embodiments, the position of the user relative to an ideal user location can be determined based on data collected by a position sensor of the sensor system 130 or by the audible signals (e.g., sound) generated by the user.

In other embodiments, the user 410 may interact with an interface device, such as the switch 110 or to adjust the polar pattern that is currently formed for the microphone assembly 200, such that the ideal user location is relocated to be co-located with the first location of the user 410. In various embodiments, the ideal user location is automatically relocated to be co-located with the first location (e.g., without interaction by the user 410) by use of an algorithm running on the control system 300 that is adapted to detect and determine the presence of a primary audible signal source.

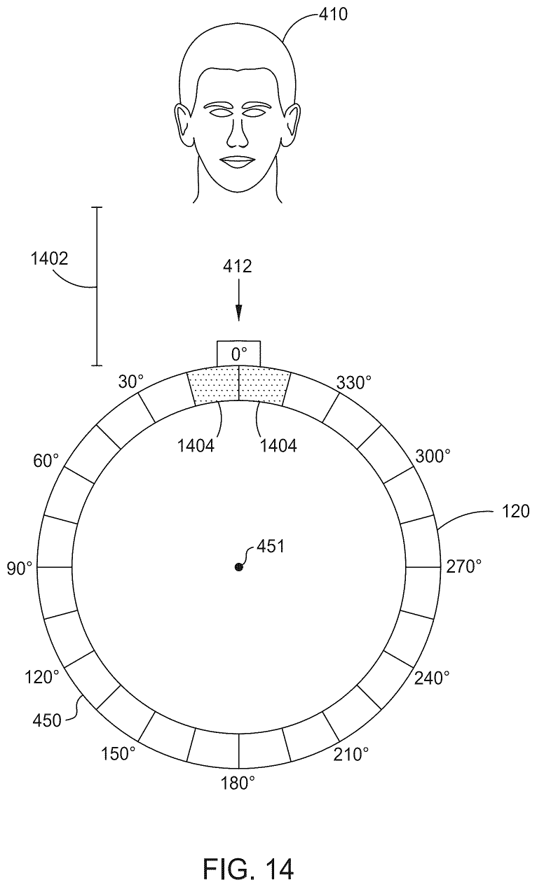

FIG. 14 is a schematic representation of displaying second visual indications 1404 of a second location of a user 410 relative to an ideal user location. As shown in FIG. 14, the user 410 is located in a second location with respect to the visual display system 120 and the microphone assembly 200. In various embodiments, one or more sensors of the sensor system 130 detect user 410 is in the second location. In one example, the sensor system 130 is able to detect the user's position at the second location as being aligned with the direction 412. The sensor system 130 also detects the user's second location as being a first distance 1402 away from the visual display system 120 and the microphone assembly 200. In this example, the ideal user location is a greater distance from the visual display system 120 than the first distance 1402 and thus the second location of the user 410 is not co-located at the ideal user location. In this case, the visual display system 120 displays the second visual indications 1404 which may indicate to the user 410 that they are not in the ideal user location and optionally indicate how to relocate to the ideal user location from the second location. The display elements 450 can provide information to a user by causing the second visual indications 1404 to emit a color (e.g., shade of red) and/or a light intensity (e.g., low intensity (200-400 lumens)) that signifies that the user is not in the ideal user location. In various embodiments, the user 410 can relocate from the second location to the ideal user location (e.g., the user 410 can physically move to the ideal user location). After adjusting their user position, the display elements 450 can provide information to the user by causing the second visual indications 1404 to emit a different color (e.g., lighter shade of red or bright shade of green) and/or a different light intensity (e.g., high light intensity (800-1600 lumens)) that signifies that the user is in the ideal user location or at least close to the ideal user location. In some embodiments, the user 410 may interact with an interface device (e.g., of the microphone system 100 or another system) to relocate the ideal user location such that the ideal user location is co-located at the second location of the user 410.

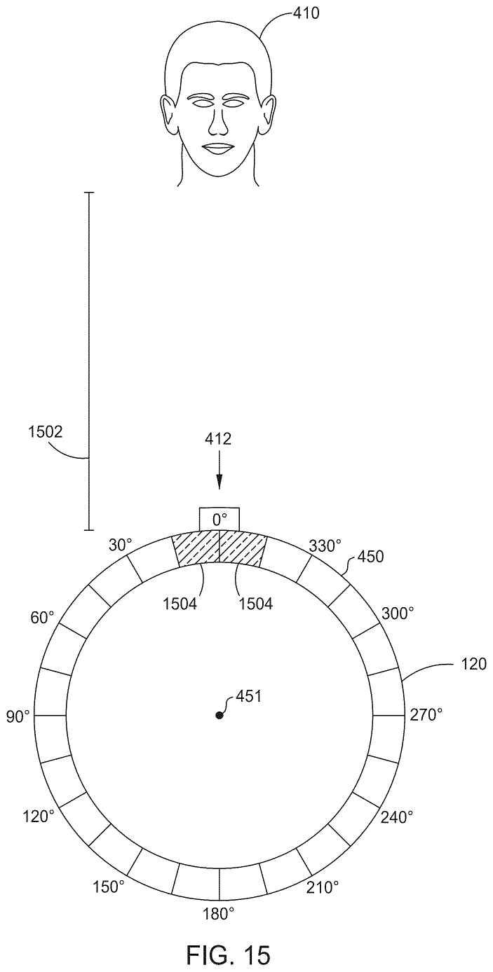

FIG. 15 is a schematic representation of displaying third visual indications 1504 based on a determination that the user is positioned at a third location of a user relative to an ideal user location. As shown, the user 410 is located in a third location with respect to the visual display system 120 and the microphone assembly 200. In some embodiments, the sensor system 130 detects the third location as being a second distance 1502 away from the visual display system 120. In these embodiments, the ideal user location is also the second distance 1502 away from the visual display system 120. In one or more embodiments, the visual display system 120 displays the third visual indications 1504 which may indicate to the user 410 that the third location of the user 410 is co-located with the ideal user location. In this example, the display elements 450 can emit one or more different colors (e.g., darker shade of green, orange, etc.) and/or a different light intensity (e.g., high light intensity (800-1600 lumens)) that signifies that the user is in the ideal user location or at least close to the ideal user location.

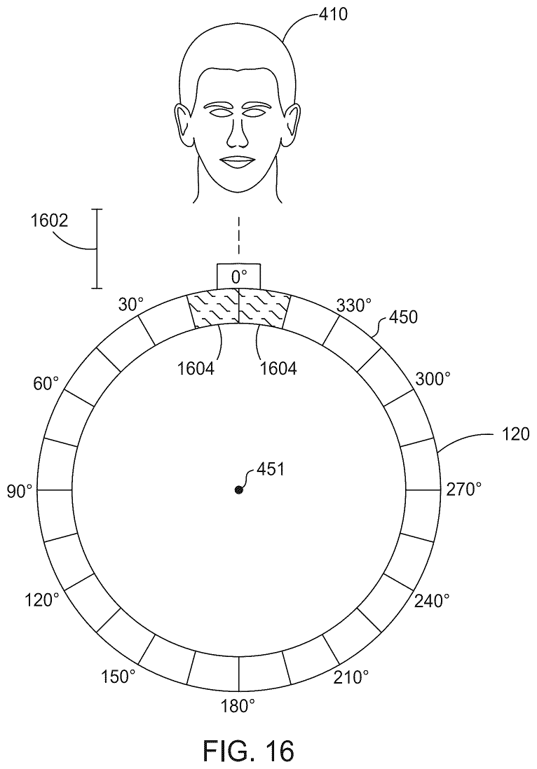

FIG. 16 is a schematic representation of displaying first visual indications 1604 of a first detected distance 1602 between a user 410 and a microphone assembly 200 irrespective of the ideal user location. As described in FIGS. 13-15 above, the sensor system 130 is capable of detecting a location of the user 410 relative to an ideal user location. As shown in FIG. 16, one or more sensors of the sensor system 130 are also capable of detecting the first detected distance 1602 between the user 410 and the microphone assembly 200. For instance, it may be desirable to detect a distance between the user 410 and the microphone assembly 200 in addition or alternative to detecting the location of the user 410 relative to the ideal user location if, for example, the user 410 is unaware of a polar pattern currently formed for the microphone assembly 200.

The visual display system 120 displays the first visual indications 1604 to be observed by the user 410. In some embodiments, the first visual indications 1604 are displayed by LEDs of the visual display system 120. In various examples, the first visual indications 1604 indicate to the user 410 that the user 410 is less than a threshold distance from the microphone assembly 200. Information relating to the threshold distance can be stored in memory and used by the control system 300 to determine if a user is in the ideal user location and/or provide information to a user about their current position relative to the ideal user location. In some examples, at the first detected distance 1602, the user 410 is undesirably close (e.g., too close) to the microphone assembly 200 (e.g., based on a polar pattern currently formed for the microphone assembly 200). In these examples, the user 410 may relocate or the user 410 can adjust the polar pattern currently formed for the microphone assembly 200 via interaction with an interface device of the microphone system 100 or another system. One skilled in the art will appreciate that the position of an audible source (e.g., user) relative to the capsule assembly 201 of the microphone assembly 200 will have an effect on, for example, the bass response and high frequency response of the audible signal received by the capsule assembly 201. In one example, a microphone assembly 200 will experience a low frequency boost at relatively close distances (e.g., 5-10 centimeters (cm)) versus the optimal user position. In another example, the microphone assembly 200 will experience a high frequency response which will tend to cause the output of a microphone to sound “tinny” (minimal bass) as one moves further away from the optimal user position.

In some embodiments, the control system 300 can include an algorithm that is adapted to automatically adjust the sound level and/or equalizer (EQ) settings applied to the audible signals received by the capsule assembly 201 of the microphone assembly 200 based on a detected proximity of a user or noise source relative to the microphone assembly 200. For example, the algorithm can be configured to adjust the EQ settings in a frequency range that is less than 500 hertz (Hz) based on a detected distance of a user to remove or minimize a low frequency boost experienced in received audible signals due to the user being positioned close to the microphone assembly. In another example, since sound level is known to drop off proportionally to an inverse of a square of the distance, in some embodiments, the control system 300 adjusts the sound level and/or EQ settings based on a detected distance of a user or a noise source and/or one or more characteristics of the microphone assembly 200. The one or more sound level detection characteristics of the microphone assembly 200 can be empirically determined for a capsule assembly 201 configuration of the microphone assembly 200 and stored in memory for use by the control system 300 in the adjustment of the EQ settings based on the detected distance of the user to the microphone system 100.

The automatic adjustment of sound level and/or EQ settings, as described herein, can be used to provide a consistent sound level and/or microphone frequency response at all distances that a user is positioned relative to the microphone assembly 200. In one or more embodiments, the microphone assembly 200 is configured to control the frequency response within a frequency range of less than 500 hertz (Hz). In one or more embodiments, the microphone assembly 200 is configured to control the frequency response within a frequency range of greater than 500 Hz. In one or more embodiments, the microphone assembly 200 is configured to control the frequency response within a frequency range of 500 Hz to 20,000 Hz. In one or more embodiments, the microphone assembly 200 is configured to control the frequency response within a frequency range of 2,000 Hz to 12,000 Hz, such as a frequency range of 4,000 Hz to 10,000 Hz.

In some embodiments, the control system 300 also includes de-noise and de-reverb algorithms that are configured to, along with the use of the generated polar pattern, remove unwanted noise found in the detected audible signals. In some configurations, the control system 300 is configured to adjust the aggressiveness of the de-noise and de-reverb algorithms based on the detected distance of a user to the microphone assembly 200. In some embodiments, undesired audible signals may be suppressed by the de-noise algorithm by use of a process that excludes audible signals that are within a known set of frequencies and/or based on the time when an audible signal is received. The undesired audible signal can be suppressed with respect to time by suppressing a portion of the sound-pressure-level (SPL) of a composite audible signal, which includes desired and undesired audible signals, during time periods in which the undesired audible signal is being received and detected. As noted above, based on the timing differences in which audible signals are received by the capsule assembly 201, the audible signatures of the desired audible signal and the undesired audible signal may be determined. For example, the times in which an audible signal is received by a first microphone capsule and a second microphone capsule are substantially equal or within a known delay can be used to that the audible signal is a desired audible signal. The aggressiveness by which the de-noise and/or de-reverb algorithms are applied, such as increasing or decreasing the suppression of portions of a composite audible signal, can be based on a linear weighting factor, exponential weighting factor, a factor that is based on the inverse of the square of the detected distance, or other desired or empirically derived weighting factor.

In some embodiments, during operation a polar pattern currently formed for the microphone assembly 200 is adjusted from a first polar pattern to a second polar pattern. For example, the user 410 interacts with an interface device to change from the first polar pattern to the second polar pattern or the second polar pattern is automatically formed by use of the control system 300 to replace the first polar pattern based on polar pattern characteristics information stored in memory and information relating to at least one attribute of the position of the user relative to the microphone assembly 100, such as the user's angular orientation relative to the microphone system 100. In this example, the first detected distance 1602 between the user 410 and the microphone assembly 200 corresponds to a distance that co-locates the user 410 with an ideal user location for the first polar pattern. However, at the first detected distance 1602, the user 410 is undesirably close to the microphone assembly 200 for the second polar pattern. The visual display system 120 displays the first visual indications 1604 which indicate to the user 410 that the user 410 is undesirably close to the microphone assembly 200 based on the use of the second polar pattern. The information provided by the first visual indications 1604 to a user can be used by the user to adjust and improve their position relative to the microphone assembly 200 and thus, for example, improve the sound quality of the audible signal detected by the microphone assembly 200.

In another example, during operation the user 410 enters an environment having the microphone assembly 200 without knowledge of a polar pattern formed for the microphone assembly 200. In this example, the user 410 moves towards the microphone assembly 200 until the user 410 is about the first detected distance 1602 from the microphone assembly 200. The visual display system 120 displays the first visual indications 1604 which indicate to the user 410 that the first detected distance 1602 is too close to the microphone assembly 200. In some embodiments, the first visual indications 1604 include a first color or another visual indication that the user 410 is very close to the microphone assembly 200 at the first detected distance 1602. In one or more examples, the user 410 can move away from the microphone assembly 200 or the user 410 may interact with an interface device to change the polar pattern formed for the microphone assembly 200.

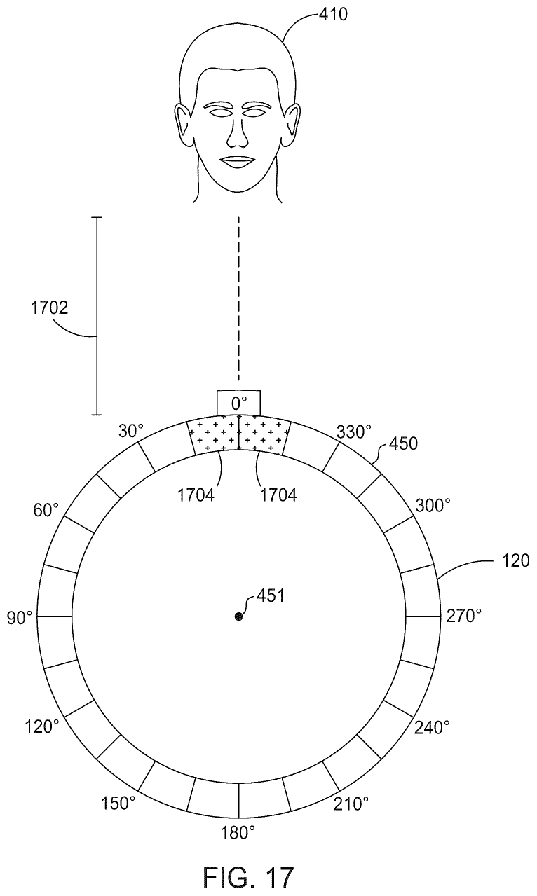

FIG. 17 is a schematic representation of displaying second visual indications 1704 of a second detected distance 1702 between a user 410 and a microphone assembly 200. Notably, the second detected distance 1702 is a greater distance than the first detected distance 1602. In some embodiments, the user 410 observes the first visual indications 1604 as described relative to FIG. 16. In these embodiments, the user 410 moves away from the microphone assembly 200 (e.g., based on observing the first visual indications 1604) until the user 410 is about the second detected distance 1702 from the microphone assembly 200. As shown in FIG. 17, the visual display system 120 is configured to display the second visual indications 1704. In some examples, the second visual indications 1704 are displayed by LEDs of the visual display system 120.

In one or more embodiments, as the user 410 is moving away from the microphone assembly 200 and the user 410 temporarily stops moving when the user 410 is about the second detected distance 1702 from the microphone assembly 200. One or more sensors of the sensor system 130 detect that the user 410 has temporarily stopped moving, and the visual display system 120 displays the second visual indications 1704 based on the sensor system 130 detecting that the user 410 has temporarily stopped moving. In some embodiments, as described with reference to FIG. 3, the microphone control system 300 causes the visual display system 120 to display the second visual indications 1704. In certain embodiments, the user 410 may cause the visual display system 120 to display the second visual indications 1704. For example, the user 410 can interact with an interface device via, for example, a gesture as described below in order to cause the visual display system 120 to display the second visual indications 1704.

The second visual indications 1704 indicate to the user 410 that the user 410 has moved away from the microphone assembly 200 and that the user 410 is the second detected distance 1702 from the microphone assembly 200. In some embodiments, the second visual indications 1704 include a second color or another visual indication (e.g., represented by a different hatch from FIG. 16) that the user 410 has moved away from the microphone assembly 200. In one or more embodiments, the user 410 may continue to move away from the microphone assembly 200 and/or the user may change the polar pattern formed for the microphone assembly 200. In various embodiments, the user 410 may interact with an interface device to cause the sensor system 130 to detect a location of the user 410 and an ideal user location based on the polar pattern formed for the microphone assembly 200.

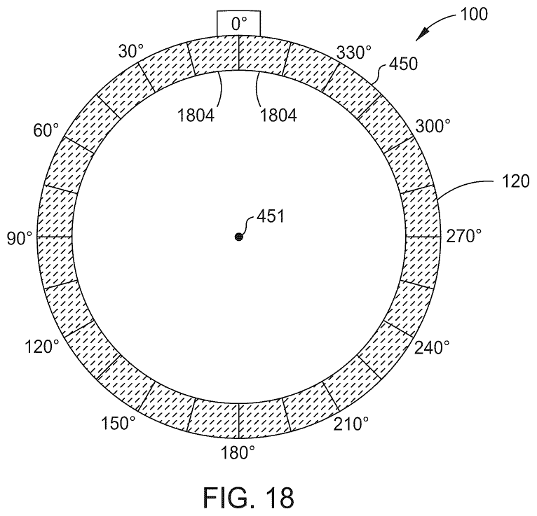

FIG. 18 is a schematic representation of displaying third visual indications 1804 of detecting no users relative to a microphone assembly 200. In some embodiments, the third visual indications 1804 include a third color or another visual indication (e.g., represented by a different hatch from FIG. 16). In one embodiment, the third visual indications 1804 include the emission of light from one or more of the display elements 450, as shown in FIG. 18. In one example, as shown, the third visual indications 1804 includes the emission of light from all of the display elements 450 (not shown) to signify that no user or audible source has been detected.

### Motion Based Interaction Examples

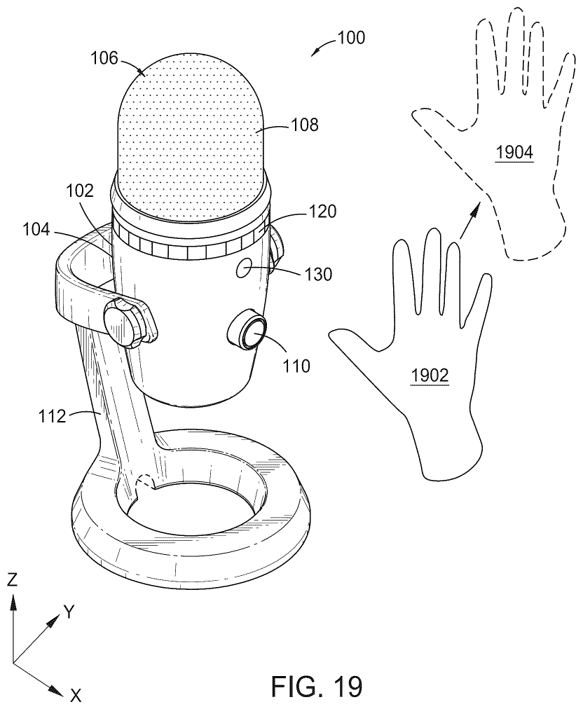

FIG. 19 is a schematic representation of a first example of a user interaction with a microphone system 100. As shown in FIG. 19, a user such as the user 410 provides user inputs to the microphone system 100 by performing one or more gestures relative to the microphone system 100, which is detected by one or more of the components within the sensor system 130. In one example, in order to make the first gesture that is detected by the sensor system 130, the user moves a hand from a first position 1902 to a second position 1904. In this example, one or more sensors of the sensor system 130 detect the first gesture based on detecting the hand moving from the first position 1902 to the second position 1904. The detected difference in the hand position can then be used by an algorithm running within the control system 300 to cause some change in control of the microphone system 100. In one example, a first gesture, which includes the movement of a user's hands in a first direction (e.g., left-to-right (+Y-direction)) relative to the microphone system 100 can cause the control system 300 to alter a first characteristic of the audible signal detection process currently being performed by the microphone system 100, such alter or change the polar pattern, adjust a sound level setting, adjust an EQ setting, adjust the orientation of a polar pattern relative to an initial orientation of the polar pattern (e.g., adjust relative to the direction 412), or other useful characteristics of the audible signal detection process. In another example, a second gesture, which includes the movement of a user's hands in a second direction (e.g., closer to the microphone system 100 (−X-direction)) relative to the microphone system 100 can cause the control system 300 to alter a second characteristic of the audible signal detection process currently being performed by the microphone system 100, such mute the microphone assembly, adjust the sound detection level, or another useful characteristic of the audible signal detection process.

In various embodiments, the first gesture can specify a variety of different types of user inputs for the microphone system 100. In some embodiments, moving the hand from the first position 1902 to the second position 1904 causes the microphone control system 300 to change a polar pattern currently formed for the microphone assembly 200, for example, to a default polar pattern. In other embodiments, making the first gesture causes the microphone control system 300 to adjust settings for one or more audio characteristics such as increasing or decreasing a gain for a signal generated by the microphone system 100.

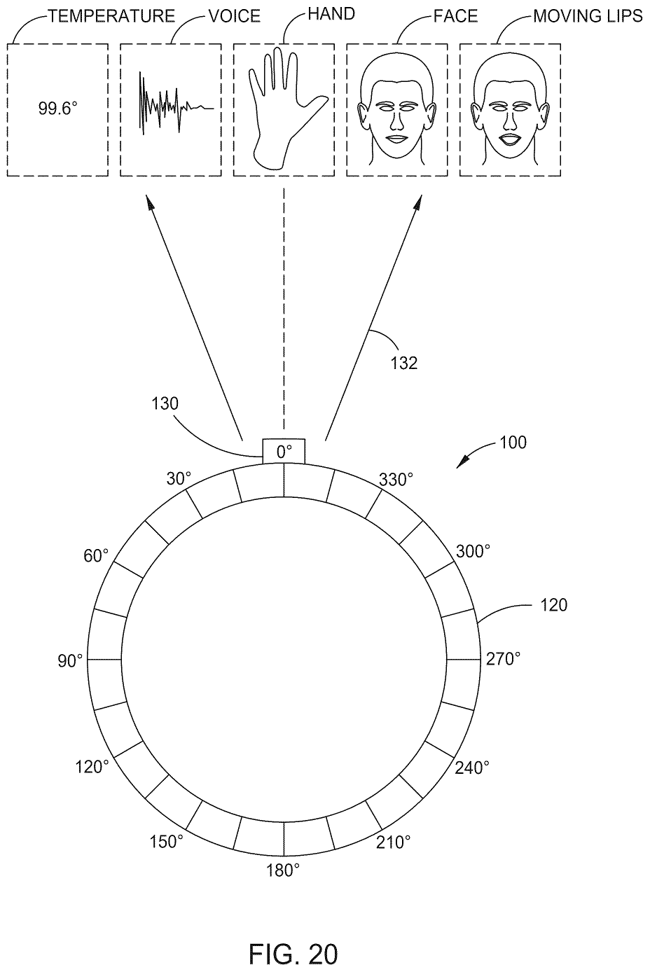

FIG. 20 schematically represents various user attributes that can be detected by the sensor system 130 by a microphone system 100, according to one or more embodiments. In some embodiments of the microphone system 100, the sensor system 130 is configured to detect one or more attributes of a user that is positioned within a field-of-view (FOV) of a sensor within the sensor system 130. In this example, the FOV is positioned between the arrows 132 shown in FIG. 20. In one embodiment, a sensor within the sensor system 130 is configured to detect the temperature of a portion of a user (e.g., user's face) by use of an optical temperature measurement technique. In another embodiment, a microphone within the microphone assembly 200 is configured to detect a characteristic of an audible signal (e.g., voice) of a user by use of an algorithm running within the control system 300 to detect a specific user is talking or an audible signal is being provided from a human rather than an animal or other noise generating device (e.g., fan, HVAC unit, etc.). In another embodiment, a sensor within the sensor system 130 is configured to detect the face of a user versus other non-exposed regions of the user or portions of the local environment by use of an optical temperature measurement technique. In yet another embodiment, a sensor within the sensor system 130 is configured to detect the movement of a feature of a user, such as the movement of a person's lips of a user. In this case, the control system 300 can detect that a specific user is talking and can use this information to learn one or more characteristics of a user, such as their speech characteristics (e.g., frequency ranges of the detected audible signal and/or other attributes of their speech) and timing of delivery of the audible signal relative to other received audible signals to help separate desired audible signals from background noise. In one example, a sensor within the sensor system 130 is configured to detect that an object is likely to be a human and the object has lips that are moving by detecting a difference in temperature of the object and a variation in the position of two or more different temperature regions as a function of time. In one example, the detected movement of a feature of a user can be used to correctly adjust and orient a generated polar pattern relative to the detected position of the user by the sensor system 130.

### Authentication and Privacy Concerns

It is believed that the ability to detect that an object (e.g., user) positioned in front of the microphone system 100 is a human by use of one or more of the sensors in the sensor system 130 and/or microphone capsules within the microphone assembly 200 can be useful to ensure that the audible signal received by the microphone assembly 200 is being received by a human and not by some other source (e.g., an artificial intelligence (AI) enabled audible source), and thus can be useful for authentication purposes. The process of providing user authentication can be helpful to ensure a desired security level is being used during operation and/or access to or delivery of various types of information (e.g., audible signals) can be controlled. The authentication process can be performed on microphone system 100 or off-loaded to software running on an external electronic device 199 coupled to the microphone system 100, such as a laptop, desktop computer, video conferencing equipment, or other electronic device(s). Once a user has been authenticated, the signal provided from the microphone system 100 to the external electronic device can include metadata that is transferred within a generated processed audible signal (e.g., digital audio signal) and/or provided within an analog audio (e.g., out of band chirps and tones) channel connected to the XLR communication link 197 or the digital communication link 198. The metadata can include an embedded watermark to assure or confirm that the user has been authenticated and/or the generated audible signals are secure.

In some embodiments, the sensor system 130 does not include a sensor that is capable of detecting personally sensitive attributes of a user, such as the sensor system 130 does not contain a camera for user privacy concerns. In this case, user authentication can be confirmed by use of one or more detected attributes of a user, such as the temperature of the object in front of the microphone system 100 is within a human body temperature range and/or the audible spectrum of a received audible signal matches characteristics of a specific user stored in memory.

### Microphone System Display Examples

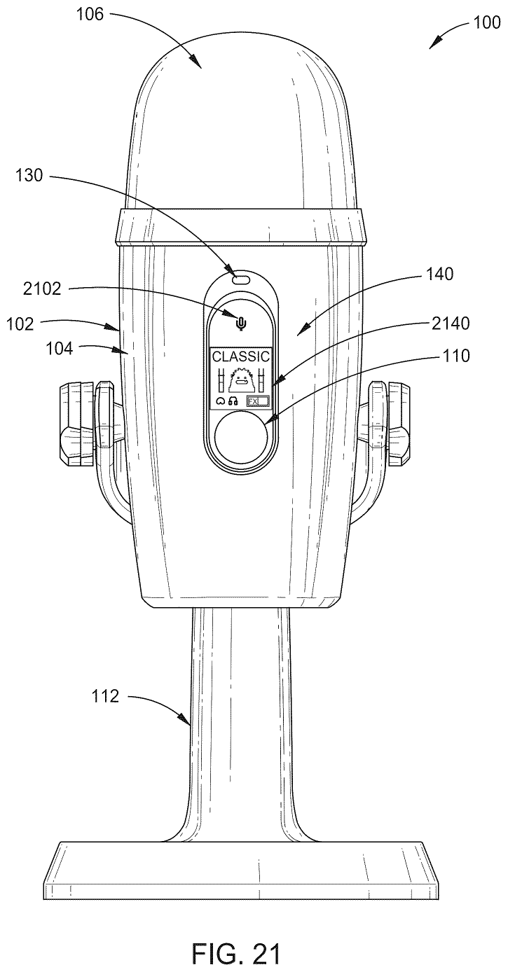

In various embodiments, as previously discussed in relation to FIG. 1B, the microphone system 100 will include a display device 140 that is configured to visually display information in addition to or as an alternative to information displayed by the visual display system 120. FIG. 21 illustrates an alternate microphone system 100 configuration that includes a version of the display device 140. As noted above, in certain embodiments, the display device 140 includes a digital display device configured to display glyphs, alphanumeric data, information related to the shape of the polar pattern (e.g., graphical representation of the currently generated polar pattern), the polar pattern beam width values, detection angles, non-zero gains, device status icons, audio control settings, or other useful metrics.

In some configurations, the microphone system 100 will include the display device 140 and also a status icon region 2102 in which one or more status icons are positioned so that a user of the microphone system 100 can easily detect the microphone's status. For example, the status icon region 2102 illustrated in FIG. 21 include an icon that is able to display whether the microphone system 100 has been muted or unmuted. In the muted case the icon may appear as a red outlined microphone and in the unmuted case the icon may be un-highlighted or be highlighted in a non-red color (e.g., green).

In some embodiments, the display device 140 will include a display region 2104 that includes a visual display unit (VDU), which is sometimes referred to herein as a monitor or screen, in which various images and alphanumeric text can be displayed to allow the user to receive information relating to activities that the microphone system 100 are performing currently, activities that can be initiated by user interaction, activities related to the control of the microphone system 100, and/or the status of various functions performed by the microphone system 100. The visual display unit can, for example, include an array of LEDs, a liquid crystal display (LCD), an in-plane switching liquid crystal display (IPS-LCD), an organic light-emitting diode (OLED), or an active-matrix organic light-emitting diode (AMOLED), or other type of display device. The display region 2104 can include a graphical user interface (GUI) that allow a user to interact with the electronic assembly 191 of the microphone system 100 through visual elements like icons, buttons, and menus. User input can be provided to the microphone system 100 by use of the switch 110 to allow the algorithms running on the microphone to control aspects of the microphone system 100 and display the results of the interaction within the display region 2104 of the display device 140.

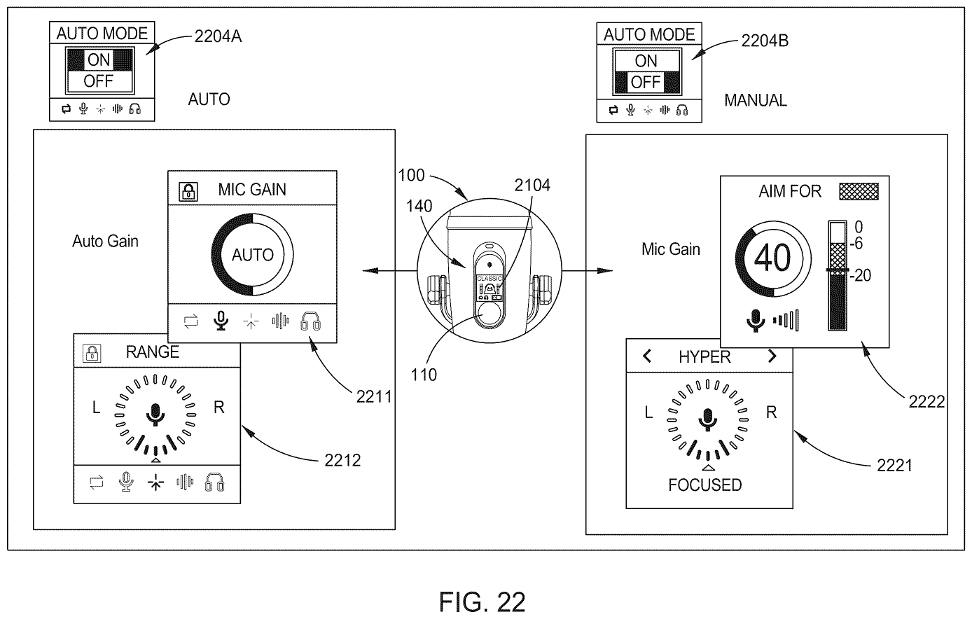

FIG. 22 is a schematic representation of alternate visual displays that can be generated on the display region 2104 of the display device 140 within the microphone system 100, according to one or more embodiments. As discussed above, in some embodiments, the control system 300 can be used to automatically adjust, one or more characteristics of the microphone system to improve the quality of a received audible signal and reject unwanted audible signals received from different sources (e.g., noise sources). In one example, the control system 300 can include an algorithm that is adapted to automatically adjust the microphone's gain level, sound level, and/or equalizer (EQ) settings applied to the audible signals received by a capsule assembly 201. As illustrated on the right side of FIG. 22, the algorithm can cause an automation selection screen, as shown in screenshots 2204A or 2204B, to be displayed in the display region 2104 of the display device 140. Then based on input received from a user, such as by the manipulation of switch 110, the user can select whether the control system 300 should enter a manual mode (e.g., screenshot 2204B) or automated mode (e.g., screenshot 2204A). When in an automated mode, the display region 2104 can display icons or graphics at different times, based on user input or the passage of time, that provide the user with information relating to status of the automated activities being performed by the control system 300. In one example, screenshot 2211, which includes a representation of the magnitude of the microphone gain level, can be generated at a first time and screenshot 2212, which includes a representation of an automated spatial detection range of the microphone, can be generated at a second time.

Alternately, when in a manual mode, the display region 2104 can display icons or graphics at different times, based on user input or the passage of time, that provide the user with information relating to activities that a user wants to manually control by use of one or more algorithms running on the control system 300. In one example, screenshot 2222, which includes a representation of a manually adjusted microphone gain level set point that is used to limit the microphone's gain level during operation, can be generated at a first time and screenshot 2221, which includes a representation of a manually adjustable spatial detection range that can be adjusted by a user providing input to the switch 110, can be generated at a second time.

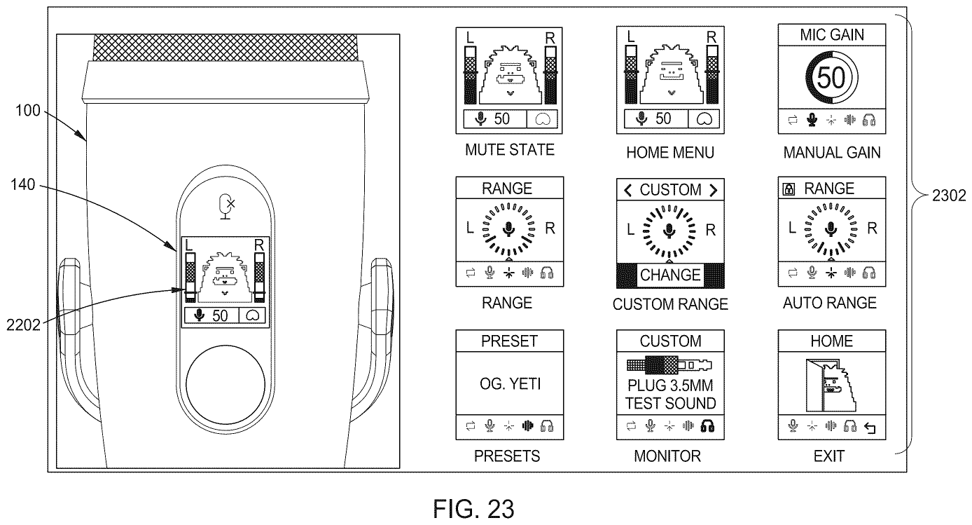

FIG. 23 illustrates a plurality of screenshots 2302 that can be separately generated within a first display region 2202 of a display device 140 within a microphone system 100, according to one or more embodiments. In one example, the display region 2104 can display a mute state screenshot, a home menu screenshot, a manual state screenshot, a manual range screenshot, a custom range screenshot, an automated range screenshot, a preset setting control screenshot, a monitor control screenshot, and an exit mode screenshot, which will each include representative icons, graphics, and/or alphanumeric information at different times based on signals provided from the control system 300 and/or input from a user.

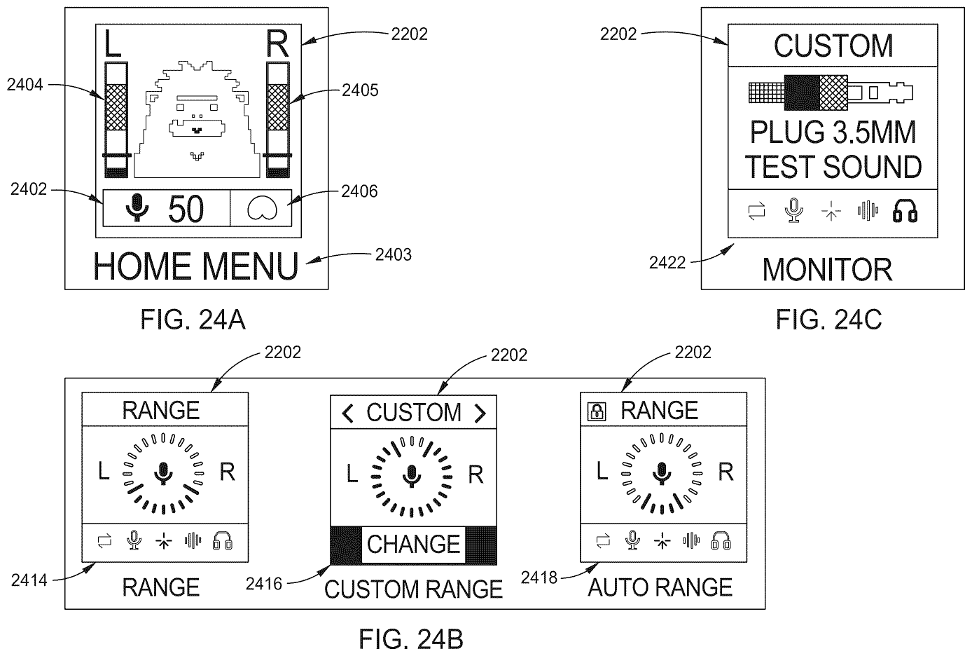

FIG. 24A illustrates an example of a screenshot that can be separately generated within the display region 2104 of the microphone system 100. As shown in FIG. 24A, the display region 2104 can include a first display region 2202 that includes a first sub-region 2402, a second sub-region 2404, a third sub-region 2405, and a fourth sub-region 2406. The first sub-region 2402 can include a graphical representation of the currently controlled gain level. The second sub-region 2404 and third sub-region 2405 can include a representation of both a left and a right balance that is controlled by the control system 300. The fourth sub-region 2406 can include a graphical representation of the current type of cardioid polar pattern and the orientation of the cardioid polar pattern relative to the front of the microphone system 100 that is being used by the control system 300. The display region 2104 can also include a region 2403 that can include an information display region that can provide alphanumeric information regarding the status, state or activities being performed by the control system 300.

FIG. 24B illustrates an example of a series of screenshots that can be generated within the display region 2104 of the microphone system 100 at different times. As shown in FIG. 24B, the series of screenshots that separately include information relating to the method of controlling the range of the microphone system 100. In this example, the first display region 2202 can include a first display 2414, a second display 2416, and a third display 2418. The first display 2414 can include a graphical representation of a manually controlled detection range level, which includes a highlighted set of icons that represent the detection range of the microphone system 100. In this example, the detection range can be represented by a differing intensity and/or color of 9 of the 24 icons represented on a portion of the first display region 2202. The second display 2416 can include a graphical representation of a custom controlled detection range level, which includes a representative set of highlighted icons that represent the custom setting of the detection range of the microphone system 100. In this example, the detection range can be represented by a differing intensity and/or color of 21 of the 24 icons represented on a portion of the first display region 2202. The third display 2418 can include a graphical representation of an automatically controlled detection range level, which includes a representative set of highlighted icons that represent the current automated setting of the detection range of the microphone system 100. In this example, the detection range can be represented by a differing intensity and/or color of 5 of the 24 icons represented on a portion of the first display region 2202.

FIG. 24C illustrates an example of a screenshot that can be generated within the display region 2104 of the microphone system 100 to provide system status information to a user. As shown in FIG. 24C, a screenshot can include information relating to instructions about the use of the microphone system 100 or information relating to an activity that is being performed by the microphone system 100.

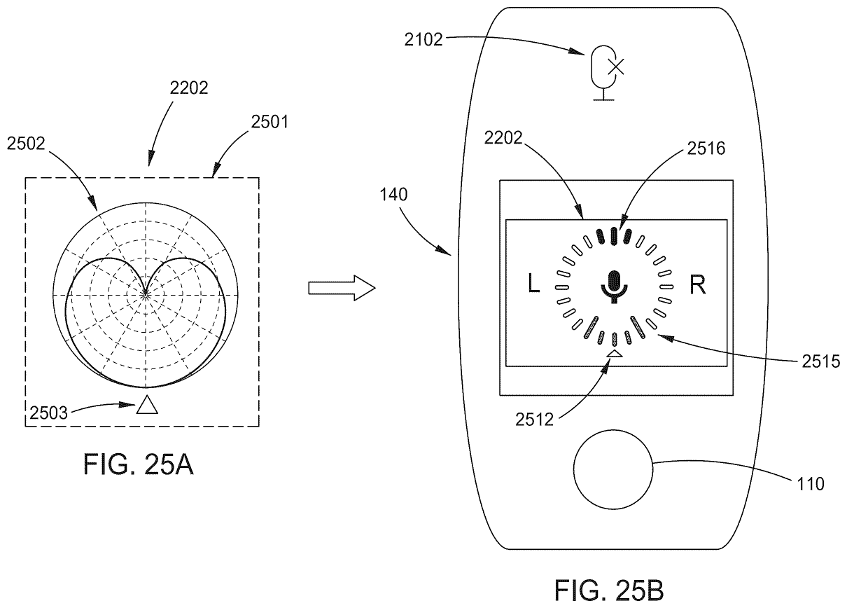

FIG. 25A illustrates a cardioid polar pattern oriented in a first orientation relative to a front region of a microphone system, according to one or more embodiments. As shown in FIG. 25A, a screenshot 2501 within the first display region 2202 can include an actual representation of the current type of cardioid polar pattern 2502 and the orientation of the cardioid polar pattern 2502 relative to the front of the microphone system 100, as illustrated by the icon 2503. The cardioid pattern illustrated in FIG. 25A is shown in a plan view orientation relative to the microphone system 100 and is intended to schematically represent the cardioid polar pattern 602 shown within the display region 2202 of the display device 140.

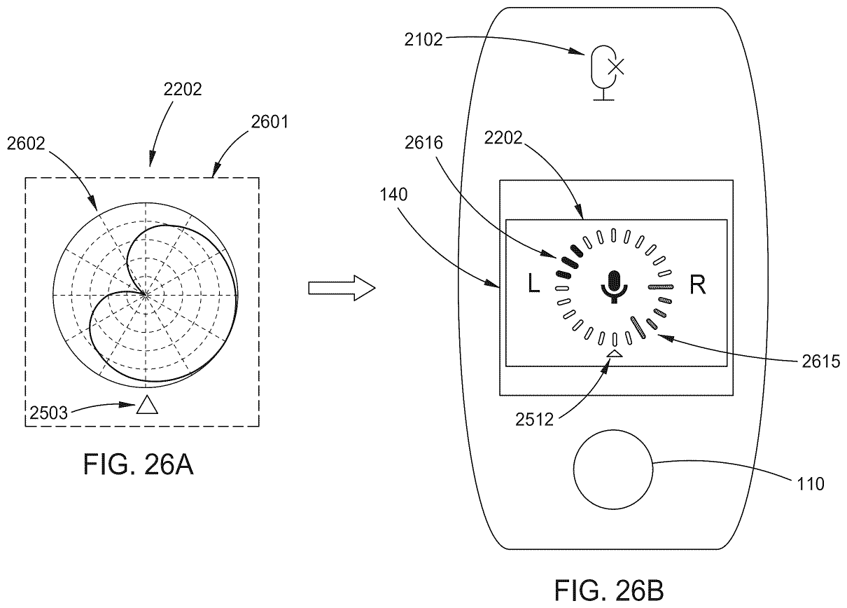

In some embodiments, the representation of a cardioid polar pattern can include a simplistic representation of one or more characteristics of the cardioid polar pattern using a plurality of icons that are displayed in the first display region 2202. In one example, as illustrated in FIGS. 25B and 26B, the plurality of icons includes an array of graphical shapes (e.g., circular array of slot shaped icons) that have a representative size, shape, orientation, color, and/or visual intensity (e.g., bright or dim) to represent one or more aspects of the one or more characteristics of the cardioid polar pattern.

FIG. 25B illustrates a screenshot of a simplified graphical display of the cardioid polar pattern illustrated in FIG. 25A, which is alternately generated within the first display region 2202, according to one or more embodiments. The representation of the cardioid polar pattern within the first display region 2202, as shown in FIG. 25B, includes a set of first visual indications 2515 displayed relative to the front (0°) of the microphone system 100, which is represented by the icon 2512, and second set of visual indications 2516 (e.g., null region). In other words, the icon 2512 can be used to represent an orientation that is associated with the front (0°) for the microphone system 100. The first set of visual indications 2515 include one or more visual features that correspond to a property and/or characteristic of the cardioid polar pattern. In some embodiments, the first set of visual indications include icons that have a first color and a first intensity (e.g., five green icons). The visual indications 2515 indicate the locations of nodes (e.g., rather than nulls) and the first intensity indicates relative sensitivity to sounds arriving at the locations of the first visual indication. The second set of visual indications 2516 include one or more visual features that correspond to another property and/or characteristic of the cardioid polar pattern. In some embodiments, the second set of visual indications include icons that have a second color and a second intensity (e.g., three red icons). The visual indications 2516 indicate the locations of a null and the second intensity indicates relative sensitivity to sounds arriving at the locations of the second visual indication. The number of icons used to represent the properties and/or characteristics of, for example, a cardioid polar pattern within the first visual indications 2515 and the second visual indications 2516 can be controlled and/or adjusted by the control system 300 based on the type and attributes of the cardioid polar pattern that is being used by the microphone system 100.

FIG. 26A illustrates a cardioid polar pattern oriented in a second orientation relative to a front region of a microphone system, according to one or more embodiments. As shown in FIG. 26A, a screenshot 2601 within the first display region 2202 can include an actual representation of the current type of cardioid polar pattern 2602 and the orientation of the cardioid polar pattern 2602 relative to the front of the microphone system 100, as illustrated by the icon 2503. The cardioid pattern illustrated in FIG. 26A is shown in a plan view orientation relative to the microphone system 100 and is intended to schematically represent an alternate orientation of the cardioid polar pattern 2502 shown in FIG. 25A within the display region 2202 of the display device 140. In this example, the cardioid pattern has been oriented at an angle of 60 degrees from the front facing direction.

FIG. 26B illustrates a screenshot of a simplified graphical display of the cardioid polar pattern illustrated in FIG. 26A, which is alternately generated within the first display region 2202, according to one or more embodiments. The representation of the cardioid polar pattern includes a set of first visual indications 2615 displayed relative to the front (0°) of the microphone system 100, which is represented by the icon 2512, and second set of visual indications 2616 (e.g., null region). The first set of visual indications 2615 include one or more visual features that correspond to the property and/or characteristic of the cardioid polar pattern. Due to the change in the orientation of the cardioid polar pattern relative to the orientation of the polar pattern shown in FIGS. 25A-25B, the first set of visual indications 2615 include icons that have a first color and a first intensity (e.g., five green icons) that are aligned and positioned within the array of icons (e.g., 24 icons) at the representative orientation angle (e.g., 60 degrees from the front orientation). The first visual indications 2615 indicate the locations of nodes (e.g., rather than nulls) and the first intensity indicates relative sensitivity to sounds arriving at the locations of the first visual indications 2615. In some embodiments, the second visual indications 2616 include icons that have a second color and a second intensity (e.g., three red icons). The visual indications 2616 indicate the locations of a null and the second intensity indicates relative sensitivity to sounds arriving at the locations of the second visual indications.

As noted above, in some configurations, the sensor system 130 can be adapted to detect the orientation and relative position of a user or audible source in relation to the position of the sensor system 130 and microphone system 100. In some embodiments, the sensor system 130 is configured to detect and generate an image having a desirable resolution that at least represents an outline, silhouette, or other general shape of an audible source (e.g., user) that is then displayed within the first display region 2202. The generated image that is displayed within the first display region 2202 can be used by the control system 300 or user to determine if the microphone system 100 is detecting a desirable audible source within an environment. The detection of the audible source can then be used by the control system 300 to adjust the type of cardioid polar pattern, the orientation of a cardioid polar pattern relative to the front of the microphone system 100, adjust one or more sound level and/or EQ settings, or other useful settings.

As discussed above, in some embodiments, one or more sensor systems 130 are configured to detect a position of an object relative to the one or more sensor systems 130. The detected position of the object can include a distance of the object (e.g., audible source, people in a room, etc.) from the sensor system 130 and/or an angle formed between the object and the first direction. Based on the information received from the sensor system 130 an algorithm executed by a processor within the control system 300 can then use the information to alter a characteristic of a polar pattern based on the detected position of the object. The characteristics can include the type of polar pattern, the alignment or orientation of the polar pattern relative to features of the microphone system 100 (e.g., front face 108) and/or position of the object, the amount of rejection or attenuation (e.g., dB) provided when using the polar pattern, or other useful characteristic of a polar pattern. The altered polar pattern can then be displayed on the first display region 2202.

In some embodiments, an algorithm stored within memory is configured to cause one or more sensor systems to detect a first position of an object relative to the one or more sensor systems at a first instant in time. Then the algorithm causes the one or more sensor systems to detect a second position of the object relative to the one or more sensor sensors at a second instant in time. The algorithm can then perform a comparison between the detected first position and the second position to determine a difference between the positions, and then alter a characteristic of a polar pattern based on the detected difference in the position of the object. In one example, the altered characteristic includes altering the orientation of the microphone polar pattern relative to a first direction based on the determined difference.

In some embodiments, the characteristic of the polar pattern can be altered by first generating a polar pattern by combining a first capsule polar pattern and a second capsule polar pattern. The process of generating the polar pattern can be performed by multiplying the first capsule polar pattern by a first weighting factor and multiplying the second capsule polar pattern by a second weighting factor. In one example, during the process of generating the polar pattern, the first weighting factor is greater than zero, and the second weighting factor is less than or equal to zero or greater than or equal to zero. The process of altering the characteristic of the polar pattern (e.g., type of polar pattern) can then include adjusting at least one of the first weighting factor and the second weighting factor. The results of altering the polar pattern can then be displayed on the first display region 2202.

In some embodiments, information relating to a detected position of an object relative to the sensor system 130 is provided to the control system 300, and then an algorithm running therein is used to compare the detected position of the object (e.g., audible source) with information relating to a position stored in memory. The algorithm can then provide information regarding the position of an object to the display device 140 based on the information obtained by the comparison.

### Audio Quality Enhancement Systems

Noise present during an audio capturing event when using the microphone system 100 can be disruptive and impact the quality of the audible signal transmitted from the microphone system 100 to an external electronic device that is present on a streaming event, recording event, video conference, meeting or other audio collection event. For example, if a first user in a first remote location (e.g., far end) are on a live streaming event, noise caused by a noise source in the near end (i.e., location where the microphone system 100 is located) such as people talking, dog barking, clicking of a mechanical keyboard, or the like can be distracting to the users that are a part of the live streaming event. The noise generated by the near end noise source, such as, for example, a peripheral device near the microphone system 100 may make it difficult for a user located at the far end to hear what the user at the near end is communicating.

One or more of the embodiments herein relate to an algorithm that can suppress noise generated from a noise source, such as a peripheral device located in a near end location from an audible signal provided to a user located at a far end location. The noise that is suppressed can also include reverberation types of noise generated in the environment in which the microphone system 100 is positioned. In one or more embodiments, one or more software applications 194, such as the controlling software program (i.e., algorithm) may include an algorithm that can be applied to suppress noise generated by one or more external audible sources. The algorithm can utilize a noise suppression model that has been generated and stored in memory to perform a noise suppression activity.

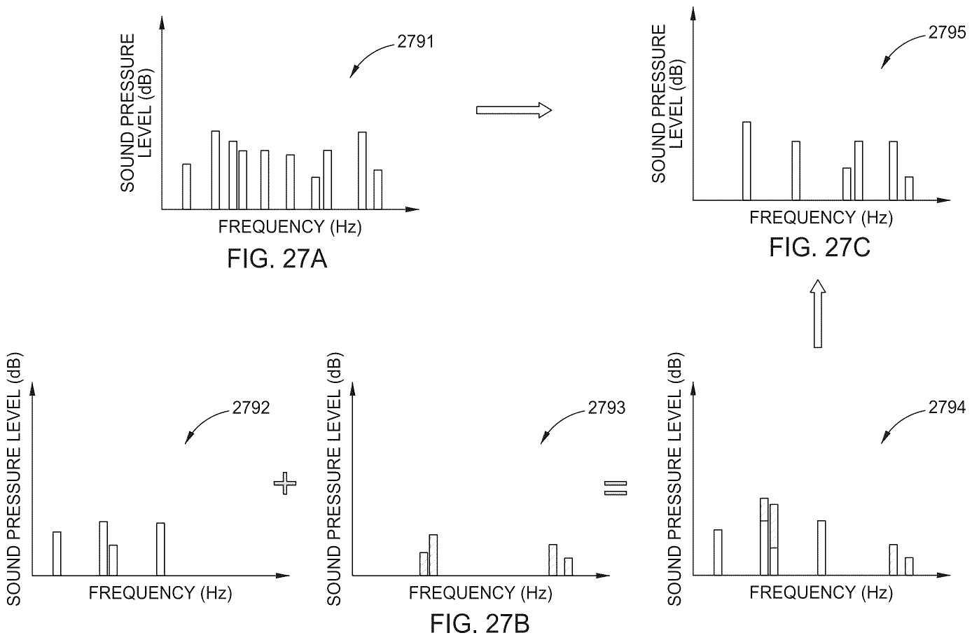

In some embodiments, the algorithm is configured to detect and suppress noise generated by known types of peripheral device(s) and specifically suppress the audible signatures of the audible noise generated by these peripheral devices. During one or more of the processes of suppressing noise(s) generated by a noise source, such as peripheral device, audio data is received by the microphone system 100, wherein the audio data has a frequency spectrum 2791. As shown in FIG. 27A, the audio data, which for discussion purposes is illustrated as quantized frequency peaks (i.e., 10 frequency spectrum peaks) that are intended to illustrate the frequency spectrum 2791 of raw audio data collected by the capsule assemblies of the microphone system 100. In this example, the audio data includes desirable audio data and noise generated by at least one noise source (e.g., peripheral device). FIG. 27B illustrates attributes of frequency spectrums for sound generated by different types of peripheral devices that can be used within one or more models during a noise suppression process. In this example, a first model has been developed to account for a frequency spectrum of a first peripheral device that has a representative first frequency spectrum 2792. A second model includes a frequency spectrum for a second peripheral device that has a representative second frequency spectrum 2793. In some embodiments, if the first and second peripheral devices include the same type of peripheral device, such as both are different types or models of mechanical keyboards, a third model that has a third frequency spectrum 2794 can be created by combining the frequency spectrums of at least two frequency spectrums of the same type of peripheral devices. In some cases, the third type of model can be used as a device class type model or even as a general model during the noise suppression activity. However, the device class type model or even a general model are not limited to models that are formed by a combination of specific device models, and can include more generalized or simplified frequency spectrums that have been developed and/or adjusted to better represent a larger number of similar peripheral devices within a genus, class or species of peripheral devices. In some embodiments, a noise suppression activity can include using one or more models to remove or suppress at least portion of audible signal to form a denoised audible signal that is then transferred to a far end user and/or second electronic device. The one or more models are thus configured to remove or suppress an attribute of the noise that is found within the raw audio data. As shown in FIG. 27C, a noise suppression activity can include applying a model, such as the third model to the originally received audible signal to form denoised audio data that has a denoised frequency spectrum 2795. Forming the denoised audio data can be completed by subtracting the third frequency spectrum 2794 from the frequency spectrum 2791 of the original audio data to form the denoised frequency spectrum 2795.

During the performance of a noise suppression activity, in one embodiment, the algorithm selects a model from the sets of models based on information stored within memory regarding a known source of noise or by input received from a user. The information stored in memory and/or input provided from a user can include information relating to the specific model number of the peripheral device that is known to generate noise, which the algorithm then uses to select a desired model to use during the noise suppression activity. For example, if a peripheral device is a mechanical keyboard, the provided information relates to a manufacturer and a model number of the keyboard, so that the algorithm can then select a model from the set of models that correspond to the specific type of keyboard.

In one or more embodiments, the one or more software applications 194 include an artificial intelligence (AI) algorithm that is used to detect and suppress noise generated by external audible sources. In general, an AI algorithm (and AI models) will include processes that require combining large sets of data with intelligent, iterative processing algorithms to learn from patterns and features in the data (e.g., audio data) that it has analyzed and/or is analyzing. Each time an AI algorithm (and AI model) runs a round of data processing, it will test and measure its own performance so as to develop additional expertise based on the performance of these activities. In this case, the algorithm is used to generate and improve the selection of an AI generated model that is used to suppress noise generated by an external noise sources and improve the noise suppression activities performed by the AI models based on received prior and current data. In some embodiments, the training performed on the AI model includes the use of audio data that describes specific audible characteristics of a plurality of devices that are to be excluded or suppressed during noise suppression activities (e.g., denoising process). The specific characteristics can include a sound pressure level (SPL) and/or characteristic noise frequencies (e.g., frequencies commonly found in an audible signal provided from a noise source (e.g., keyboard key click)).

### Sound Quality Metrics

During operation, an algorithm can provide information to a user relating to a sound quality of an audible signal provided from the microphone system 100. Sound quality metrics are generally used to objectively measure a perceived sound quality by quantifying aspects of received and/or processed audible sound such as loudness, sharpness, and roughness, or even signal-to-noise ratio, rather than just sound pressure levels (SPLs). The sound quality metric can be represented within the first display region 2202 as a rational number that is within a range between 0 and 10 or be shown in a graphical form such as one of the graphical representations illustrated in one of the plurality of screenshots 2302 shown in FIG. 23 (e.g., an icon similar to the center icon in the “Manual Gain” screenshot).

In some embodiments, the algorithm can use the sound quality metric to automatically and in real-time adjust aspects of the audible signal collection and processing process to improve the quality of the audible signal transmitted from the microphone system 100. In some cases, the algorithm adjusts one or more audible signal quality affecting parameters based on the collection and comparison of the components used to form the sound quality metrics, such as loudness, sharpness, roughness, SPL level, and/or signal-to-noise ratio as the one or more audible signal quality affecting parameters are varied. In one example, the one or more audible signal quality affecting parameters can include a desired type of cardioid pattern, orientation of the selected cardioid pattern relative to the front of microphone system 100 and desired audible signal generation sources (e.g., user), selection of a noise suppression model, or other audible signal affecting characteristic. The adjustment process can include comparing the effect of varying at least one of the audible signal quality affecting parameters, which had a first value at a first instant in time and, after varying the one or more audible signal quality affecting parameters, a second value at a second instant in time. In other words, the algorithm can adjust one or more of the audible signal quality affecting parameters to maximize the sound quality metric produced by the microphone system 100 based on a comparison of the effect that varying the one or more audible signal quality affecting parameters has on sound quality.

In one additional example, during the performance of a noise suppression process, the noise suppression algorithm can provide information relating to one or more sound quality metrics of the audible signal provided from the microphone system 100 based on the noise suppression activities being performed by the algorithm within the display device 140. In this example, the algorithm can adjust one or more audible signal quality affecting parameters based on the collection and comparison of the components used to form the sound quality metrics, such as the noise suppression model used by the algorithm, type of cardioid pattern, characteristics of the selected cardioid pattern, and other sound quality affecting parameters such as loudness, sharpness, roughness, SPL level, and/or signal-to-noise ratio.

While the foregoing is directed to embodiments of the present disclosure, other and further embodiments of the disclosure may be devised without departing from the basic scope thereof, and the scope thereof is determined by the claims that follow.

1. A microphone assembly, comprising:
a first microphone capsule configured to generate a first capsule polar pattern;
a second microphone capsule configured to generate a second capsule polar pattern, wherein the first microphone capsule and the second microphone capsule are each aligned relative to a first direction;
a microphone control system configured to:
receive a first audible signal from the first microphone capsule;
receive a second audible signal from the second microphone capsule; and
generate a microphone polar pattern based on a combination of the first capsule polar pattern and the second capsule polar pattern; and
a visual display system comprising a display that is configured to display a characteristic of the generated microphone polar pattern based on information received from the microphone control system.

2. The microphone assembly of claim 1, wherein the displayed characteristic of the microphone polar pattern is configured to represent an alignment of the characteristic of the microphone polar pattern relative to the first direction

3. The microphone assembly of claim 1, wherein the display comprises a visual display unit.

4. The microphone assembly of claim 3, wherein a displayed characteristic of the microphone polar pattern on the visual display unit is displayed using one or more icons that are configured to represent a characteristic of the generated microphone polar pattern by emitting light at one or more wavelengths and one or more light intensities.

5. The microphone assembly of claim 3, wherein the visual display unit comprises a liquid crystal display (LCD), an in-plane switching liquid crystal display (IPS-LCD), an organic light-emitting diode (OLED), or an active-matrix organic light-emitting diode (AMOLED) type of display device.

6. The microphone assembly of claim 3, wherein
the microphone polar pattern comprises a node configured to receive audible signals arriving in the first direction and a null configured to receive audible signals arriving in a second direction, and
the displayed characteristic of the microphone polar pattern on the visual display unit is displayed using one or more icons that are configured to represent a characteristic of the generated microphone polar pattern by emitting light at one or more wavelengths and one or more light intensities.

7. The microphone assembly of claim 3, wherein
the microphone polar pattern comprises a node configured to receive audible signals arriving in the first direction and a null configured to receive audible signals arriving in a second direction, and
the displayed characteristic of the microphone polar pattern on the visual display unit is displayed using an actual representation of the microphone polar pattern.

8. The microphone assembly of claim 3, wherein the microphone polar pattern comprises a node configured to receive audible signals arriving from a second direction that is at an angle to the first direction, and
the displayed characteristic of the microphone polar pattern on the visual display unit includes a representation of the node at an orientation that is at an angle to a displayed orientation that is associated with the first direction.

9. The microphone assembly of claim 1, wherein
combining the first capsule polar pattern and the second capsule polar pattern comprises multiplying the first capsule polar pattern by a first weighting factor and multiplying the second capsule polar pattern by a second weighting factor,
the first weighting factor and the second weighting factor are stored in a memory that is in communication with the microphone control system,
the first weighting factor is greater than zero, and
the second weighting factor is less than or equal to zero or greater than or equal to zero.

10. The microphone assembly of claim 1, wherein
combining the first capsule polar pattern and the second capsule polar pattern comprises multiplying the first capsule polar pattern by a first weighting factor and multiplying the second capsule polar pattern by a second weighting factor,
the first weighting factor is greater than zero,
the second weighting factor is less than or equal to zero or greater than or equal to zero, and
the microphone assembly further comprises a switch that has a first position and a second position, and
wherein, when the switch is shifted from the first position to the second position, the shift in the position causes at least one of the first weighting factor and the second weighting factor to be altered.

11. The microphone assembly of claim 1, wherein
the microphone polar pattern comprises a node configured to receive audible signals arriving in the first direction and a null configured to receive audible signals arriving in a second direction, and
the microphone assembly further comprises a display device oriented and positioned to display information to a user positioned along the first direction.

12. The microphone assembly of claim 1, further comprising a status icon region that includes one or more status icons, wherein the status icon region is aligned with the first direction.

13. A microphone assembly, comprising:
a first microphone capsule configured to generate a first capsule polar pattern;
a second microphone capsule configured to generate a second capsule polar pattern, wherein the first microphone capsule and the second microphone capsule are each aligned relative to a first direction;
a microphone control system configured to:
receive a first audible signal from the first microphone capsule;
receive a second audible signal from the second microphone capsule; and
generate a microphone polar pattern based on a combination of the first capsule polar pattern and the second capsule polar pattern;
one or more proximity sensors having a field-of-view that is aligned relative to the first direction, and the one or more proximity sensors are configured to detect an angular position relative to the first direction and distance of an object positioned within the field-of-view from the one or more proximity sensors; and
a visual display system comprising a display that is configured to display a representation of the object.

14. The microphone assembly of claim 13, wherein the display comprises a visual display unit.

15. The microphone assembly of claim 14, wherein the visual display unit comprises a liquid crystal display (LCD), an in-plane switching liquid crystal display (IPS-LCD), an organic light-emitting diode (OLED), or an active-matrix organic light-emitting diode (AMOLED) type of display device.

16. The microphone assembly of claim 13, wherein the field-of-view of the one or more proximity sensors has an angle measured in a horizontal plane that is between about 10° and about 180°.

17. The microphone assembly of claim 13, wherein the display is configured to display a characteristic of the generated microphone polar pattern based on information received from the microphone control system.

18. The microphone assembly of claim 13, wherein the one or more proximity sensors comprises a multi-zone proximity sensor.

19. The microphone assembly of claim 13, wherein
the visual display system is configured to display a characteristic of the generated microphone polar pattern based on information received from the microphone control system, and
the displayed characteristic of the microphone polar pattern is aligned relative to the first direction.

20. The microphone assembly of claim 19, wherein a displayed characteristic of the microphone polar pattern on the visual display system is displayed using one or more icons that are configured to represent a characteristic of the generated microphone polar pattern by emitting light at one or more wavelengths and one or more light intensities.
